(19) United States
(12) Patent Application Publication
(10) Pub. No.: US 2026/0355795 A1
(43) Pub. Date: Nov. 12, 2026

(54) A CONTAINER REUSE SYSTEM HAVING A CONTROLLED CLEANING SYSTEM

(71) Applicant: Six:AM Pty Ltd, Black Rock, Victoria (AU)

(72) Inventors: Michael Julian Vandertop, Black Rock, Victoria (AU); Joseph Marco Angele, Melbourne, Victoria (AU); Saeed Mafi, Mooroolbark, Victoria (AU); Amy Tayla Petts, Croydon, Victoria (AU)

(21) Appl. No.: 19/139,844

(22) PCT Filed: Nov. 10, 2023
(86) PCT No.: PCT/AU2023/051142

§ 371 Date: Jun. 16, 2025

(30) Foreign Application Priority Data
Dec. 14, 2022 (AU) 2022903840

(51) Int. Cl. B08B 9/28; A47L 15/00; A47L 15/42

(52) U.S. Cl. CPC B08B 9/28; A47L 15/0021; A47L 15/0065; A47L 15/0076; A47L 15/4202; A47L 15/4291; A47L 2401/04

(57) ABSTRACT

A container reuse system for cleaning containers so as to allow reuse of a container in a cleaned state, the system including: a container receiving station formed and configured to be able to receive a container to be cleaned; a cleaning device cooperating with the container receiving station and configured to clean the container in the container receiving station; and a controller configured to control the cleaning device relative to the container to enable the container to be readily cleaned.

### CROSS-REFERENCE TO RELATED APPLICATIONS

This application is a continuation-in-part of International Patent Application No. PCT/AU2023/051142 filed on Nov. 10, 2023, which claims the benefit of Australian Provisional Patent Application No. 2022903840 filed on Dec. 14, 2022, the contents of which are incorporated herein by reference in their entirety.

### FIELD OF THE INVENTION

The present invention relates to a container reuse system and in particular to such a system having controlled cleaning.

The invention has been developed primarily for use with controlled reuse of containers in the takeaway coffee industry and will be described hereinafter with reference to this application. However, it will be appreciated that the invention is not limited to this particular field of use.

The term “containers” throughout this document includes food carrying containers which includes cups, bottles, punnets, buckets, burger boxes and their respective lids and straws etc. Two particularly relevant containers are water bottles used for personal hydration and cups used for ranges such as coffee, but containers are not limited to these.

### BACKGROUND OF THE INVENTION

Every year, over 500 billion takeaway cups pile up in landfill, forming the coffee industry's ugliest footprint. Annual consumption of plastic bottles is set to top half a trillion by 2021, is far outstripping recycling efforts and jeopardizing oceans, coastlines and other environments. These figures are increasing exponentially.

The indicator known as “Earth Overshoot Day” marks the date when humanity has used all the biological resources that earth regenerates during the entire year. Ending single use packaging would directly move and improve the date of Earth Overshoot Day by:
(a) reducing the carbon emissions associated with manufacturing processes;
(b) reducing the overwhelming amounts of litter in our environment; and/or
(c) preventing the chemical leakage from plastics not only in our environment but in our food.

People have considered recycling as the answer. However, recycling single use items is akin to managing the effects caused by a situation rather than preventing the situation occurring in the first place.

In recycling as a minimum, a single use item needs to be collected, transported to a sorting station, sorted, cleaned and reconfigured or remanufactured or rejuvenated ready for reuse in most cases at a different location. All these steps have an environmental impact.

In most cases a lot of single use items cannot be recycled or have a limited recycling circuit. This is due to the many hands the article passes through with no party maintaining control. Further because of the lack of control, health and safety issues cannot be maintained at acceptable limits. Therefore, as a “safety measure” many possible recyclable articles are sent to landfill or to full reprocessing back to constituent elements and remanufacturing. This destroys nearly all the benefits of recycling.

Therefore, recycling is not the answer for at least the reasons of:
needing to generate new products out of old products;
well-known, more common, better supported;
recycled products are often of lesser quality since the raw ingredients degrade into smaller finer particles rather than the initial range of sizings giving best structural integrity;
environmental and labor costs of collecting and processing the used products make recycling difficult and expensive;
generally, the product must be cleaned first on a production line with a multitude of shapes and types of products and therefore cleaning systems are not matched to individual products and cleaning is often not up to health standards for use as a food container; and
most products cannot be infinitely recycled and therefore recycling is not a long-term solution.

This invention therefore requires mechanical washing, rinsing, sanitizing and drying of containers which means a food carrying container which includes cups, bottles, punnets, buckets, burger boxes and their respective lids and straws. Traditionally containers such as but not limited to cups, glasses, plates, bowls, containers etc. are placed in racks in a dishwashing machine that cleans said container in either stationary racks with moving wash pipes or moving racks with fixed or a combination of both.

Specifically in the reusable cup sector the aim is to have a system whereby an individual person can have a simple method to wash said cup. In most cases cups are collected and processed in small or large batches. Ideally cups would be washed and sanitized individually and although such machines exist, they are restricted to special containers or operating methods. Other systems collect the cups for bulk cleaning and redistribution.

A simple solution would be for a person to keep their own cup. However, due to their design current methods claim to be capable of sanitizing a clean cup but they cannot cope with too much waste. Some systems use steam for sanitation; however, too much energy is required to heat the steam and then cool the cup down, so it is safe to handle.

Fast food chains such as but not limited to hamburger take away restaurants use disposable recyclable boxes for their food. There is no method to clean a reusable hamburger box.

It has been proven that reusable drinking bottles can carry a lot of bacteria if not cleaned properly and regularly. Current bottle washing machines only focus on washing the actual bottle; however, the straw and teat used in modern bottles is a health risk. Bottles can be filled with water from a tap or dispenser, but there is no system that allows a bottle to be filled with other drinks such as lemonade, cola, coffee, soup etc. Incorporated within our cleaning apparatus is a drink dispenser (hot or cold, still or carbonated) that can be used to fill customer's clean and sanitized bottle. Usual domestic or commercial dishwashers are not.

It can be seen that known prior art container recycling systems have the problems of:
(a) increase in waste being disposed of in landfill;
(b) failure of recycling such that Australia (for example) had only been recycling 16 percent of plastics over the past four years;
(c) products cannot reach set standards in sustainability, hygiene, and hydration;
(d) lack of success in use and reuse, and increasing failures due to how precincts, workplaces, events and cities need to go disposable free and need to avoid the collection and rehandling needed for recycling;
(e) So called “keep cups” have been in use for many years and have contributed to the reduction of single use items. However, there is little or no control over the cleanliness of these containers. The condition of the container could have a significant impact on the quality of the product being served by a third party or even worse the hygiene state and possible consequences for public health.
(f) There are systems whereby soiled/used keep cups are exchanged for clean ones. These systems are often linked to specific suppliers and still require collection, sorting, cleaning and redistribution.

Extensive testing and market research have highlighted the following problems with all current washing apparatus:
(a) There is no system for removal of waste product in the containers before being washed within a wash chamber, and generally waste in dishwasher systems is trapped in the cycle and therefore washing requires circulating water to pass through or over waste.
(b) Systems generally require service after every use such as cleaning material for new cycle, selection of new cycle and removal of refuse caught in the system from previous cycle which is like most washing systems including all dishwashers.
(c) Current systems cannot be used as a standalone system at commercial or community venues to allow a service to improve the environment.
(d) Current systems cannot undertake drying of the containers quickly and cost effectively without raising the temperature.
(e) There is difficulty with cleaning straws and drinking teats without use of brushes.
(f) Customers cannot wash their own containers and have it quickly returned.
(g) Current systems do not reduce water usage and maintain safe temperatures.
(h) Multiuse is not possible for different types of containers with or without tracking devices.
(i) There is no verification to show that containers have been adequately and safely cleaned and therefore reuse is not possible as the risk of contaminated containers being used is unacceptable.

The present invention seeks to provide a controlled container reuse system, which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to the invention, there is provided a container reuse system for allowing the reuse of a container in a cleaned state, the system including:
(a) a container receiving station formed and configured to be able to readily receive a container to be cleaned and reused;
(b) a cleaning device cooperating with the container receiving station and configured to be able to readily clean the container in the container receiving station; and/or
(c) a controller configured to control the cleaning device to enable the container to be readily cleaned and reused.

In one important element of the invention there is provided a container reuse system wherein the controller coordinates with the container to provide a defined cleaning process and transfers data regarding the clean process to the container which can be read at a reuse station. This can include the controller having a clock for identifying time of cleaning and extent of cleaning and transfers data regarding the cleaning process to the container which can be read at a reuse station.

As can be understood in this way a location such as a coffee shop that is going to reuse the container knows to the extent of cleaning and the timing of how long ago cleaning occurred and how often. This gives surety to the establishment that reuse of the container will result in a quality uncompromised product by reusing the container.

The invention can also provide the container receiving device is mountable within the cleaning device by at least one pivot point for allowing spinning of the container receiving device. The container receiving device rotates at a low rate, allowing liquid to be received on a container and parts in the container receiving device. The container receiving device rotates at a high rate, allowing liquid on the container and parts in the container receiving device to be removed by centrifugal forces.

The cleaning device can include a liquid circulation system including:
(a) a liquid retention chamber able to receive the container receiving station and retain liquid or solids therein;
(b) a liquid feed into the liquid retention chamber to wash or rinse the container and parts in the container receiving device; and/or
(c) an openable sump for selectively exiting liquid or solids from the liquid retention chamber.

The liquid circulation system includes connections to a first tank and a second tank wherein clean liquid can be fed to the first tank and purged water from the openable sump can be fed to the second tank wherein the water from second tank can be reused in a step of the cleaning process.

The system can include:
(i) a first refuse removal step;
(ii) a cleaning step;
(iii) a rinsing step; and/or
(iv) a drying step.

A refuse system for purging refuse can be included with:
(a) the openable sump for allowing flushing of refuse in a first action;
(b) a pump for drawing liquid and solids into the sump;
(c) a filter for allowing substantial separation of liquids and solids; and/or
(d) a rubbish trap for retaining separated solids while allowing passage of liquids back to the liquid recirculation system.

Preferably the openable sump includes a curved direct pipe, and the pump is offset to the pipe to allow clear unhindered flow to the filter and rubbish trap when the openable sump is open.

The filter can be a pyramidal filter whereby solids are able to slide down the greater quantity of surface area of filter while allowing ready transmission of the liquids. The rubbish trap with the pyramidal filter can allow solids to accumulate but still allow water flow for the wash cycles and thereby can be emptied at maintenance periods rather than each wash cycle.

According to a further aspect of the present invention, there is provided a container reuse system for allowing reuse of a container in a cleaned state, the system including a container formed and configured to be able to be readily cleaned and reused, a cleaning device configured to be able to readily clean the container and a controller configured to control the cleaning device to enable the container to be readily cleaned and reused.

It can be seen that the most cost effective and least impact on the environment is a model whereby a product is simply reused with minimal input of resources.

Therefore, to fulfil this aim it is preferable to:
(a) provide a suitable container that can be reused infinitely if made from the correct materials;
(b) conserve resources and reduce energy consumption;
(c) limit use of plastic in certain applications as it is not ideal for taste and experience;
(d) overcome the problem of being cleaned by user then the cleanliness not guaranteed; and/or
(e) note that plastic does have an end of life and cannot be infinitely recycled unlike glass.

The invention also provides a method of providing a container reuse system including the steps of:
(a) provide a cleaning device enabling cleaning of a particular container separately;
(b) receiving a required cleaning instruction regarding a particular received container;
(c) undertake the cleaning instruction regarding the particular received container;
(d) provide an output showing the particular received container has undertaken the required cleaning as instructed; and
(e) undertake a reuse of the received container has been shown to have undertaken the required cleaning as instructed.

The system invention allows the container user to clean and sanitize their item on the spot for immediate reuse. No collection or accumulation. Simply place the soiled container in the unit to be washed and sanitized ready for use. An inbuilt microchip will register the cleaning process and automatically notify the supplier that the container has recently been cleaned and sanitized. This inbuilt microchip can also register other parameters such as: owner of container, when and how last sanitized automatically, and/or charge to account for rage loyalty program.

Preferably the criteria to be met is the development of a system of reusable cup/bottle/container washer. This requires:
washing quicker than it takes to get a coffee;
wash one cup at a time;
environmental friendliness;
sustainable cleaning products;
recycled water;
low water consumption;
self-cleaning/sanitizing; and/or
glass smart cups, bottles, and containers used to unlock washing stations and linked to loyalty programs.

The system can further include:
smart products utilizing inbuilt chips for various uses;
providing not just coffee cups but also water bottles and containers;
products are to be made from fully recyclable premium materials;
full washing systems available to the public that wash and sanitize the product;
compliance with HACCP guidelines
washing system that can include smart screens for advertising, entertainment, and ordering ahead; and/or
a system that is not exclusive to anyone or any store.

The containers can be used for coffee/tea, cold rages (soft drinks/water), delicatessen items such as meats, cheese, dips, olives. It can be seen that the invention of controlled cleaning provides the benefit of design and development of a strong and responsible supply chain of innovative products that support the reduction of land waste, energy consumption, carbon footprint and provide education across the entire global cafe community. It provides a win-win for the consumer, the retailer, corporate, authorities, and most importantly the environment and community. There is reduction of land waste, energy consumption, carbon footprint, provide education and value.

This invention consists of five elements: the housing, the container, the washer/sanitizer, the dispenser and the program.

In one form the invention provides a controlled cleaning apparatus for controlled reuse of containers in required condition, including:
(a) access port for upload of a container to at least one cleaning mechanism;
(b) at least one security device for allowing a container of each of a plurality of users to provide a user-particular input to the access port;
(c) at least one display device for allowing display of an output to at least one of each of the plurality of users;
(d) at least one device for transmitting cleaning status of each user-particular container provided to the access port; and
(e) at least one receiver for receiving by at least one device for transmitting cleaning status for allowing identification of status of the respective confirmed container for at least one of each user.

Other aspects of the invention are also disclosed.

### BRIEF DESCRIPTION OF THE FIGURES

Notwithstanding any other forms which may fall within the scope of the present invention, preferred embodiments of the invention will now be described, by way of example only, with reference to the accompanying drawings in which:

FIG. 1 is a plurality of diagrammatic views of a standalone cleaning device for use in the controlled container reuse in accordance with a preferred embodiment of the present invention;

FIG. 2 is diagrammatic view of the components of a controller and cleaning device-controlled reuse system in accordance with for use in the controlled container reuse in accordance with a preferred embodiment of the present invention;

FIGS. 3 and 4 are diagrammatic views of the method of reuse of a container using the status transferred with the container in the controlled container reuse system in accordance with a preferred embodiment of the present invention;

FIG. 5 is a diagrammatic example of a secondary use of the standalone cleaning device of the invention providing a rehydration station;

FIGS. 6 and 7 are diagrammatic component views of the embodiment of the cleaning device of FIG. 1;

FIG. 8 is a diagrammatic flow diagram of component views of the cleaning device of FIG. 1 in accordance with a preferred embodiment of the present invention having a rotating wash blade with attached rotating scraper;

FIG. 9 is a diagrammatic flow diagram of component views of the cleaning device of FIG. 1 in accordance with a further preferred embodiment of the present invention having a rotating wash table with fixed water jets and centrifugal drying;

FIGS. 10 to 14 are diagrammatic views of parts and details of a particularly preferred embodiment of apparatus for use in a container reuse system for cleaning containers in accordance with the invention in which:

FIG. 10 shows the main components stripped away from the outer housing;

FIG. 11 shows detail of the washing table of FIG. 10;

FIG. 12 shows details of the filtering system of FIG. 10;

FIG. 13 shows details of the openable sump for use as the gravitational and suctional water collector below the washing table of FIG. 10;

FIG. 14 shows the detail of the pyramid filter and other relative workings of the pump and openable sump of FIG. 10;

FIG. 15 is a diagrammatic operational view of the container reuse system for cleaning containers showing the operational relationship and defined pathways A, B, C, D, E, F, G, H, I, J, and K;

FIG. 16 is a diagrammatic box view of a method of providing a container reuse system in accordance with a preferred embodiment of the present invention;

FIG. 17 is a diagrammatic box view of a method of a container with RFID device for use in a container reuse system in accordance with a preferred embodiment of the present invention;

FIGS. 18 to 21 are diagrammatic views of actual embodiments with outside casing stripped away showing piping and the flow through piping in the different cycles of Purge Cycle, Wash Cycle, Rinse Cycle, and Spin Cycle.

### DESCRIPTION OF PREFERRED EMBODIMENTS

It should be noted in the following description that like or the same reference numerals in different embodiments denote the same or similar features.

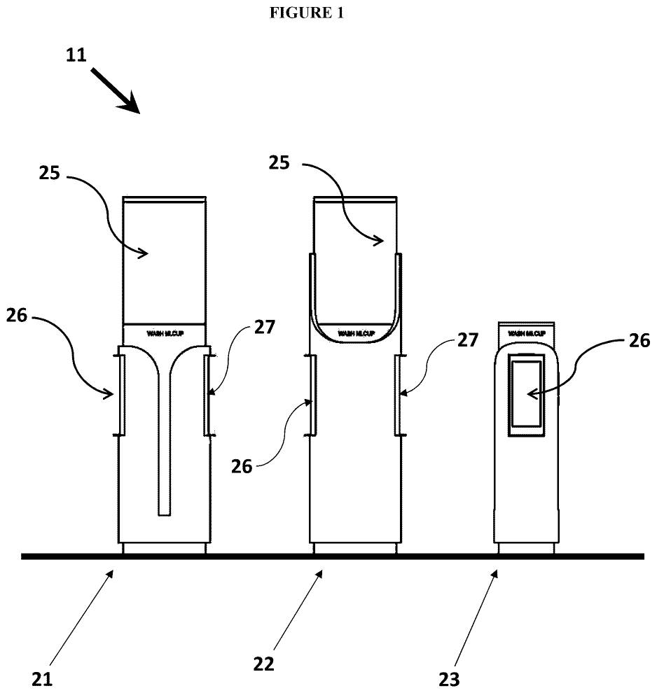

Referring to the drawings, there is shown in FIG. 1 a variety of standalone controlled cleaning devices (21, 22, 23) for use in the container reuse system (11) of the invention. The cleaning devices (21, 22, 23) include a water supply (25) which can be an inbuilt tank, a replaceable reservoir or a direct feed respectively and each including a cleaning compartment (26) that can receive a container (15) such as a coffee cup for cleaning before reuse.

The container reuse system for allowing reuse of a container in a cleaned state, the system includes a container formed and configured to be able to be readily cleaned and reused, a cleaning device configured to be able to readily clean the container, and a controller configured to control the cleaning device to enable the container to be readily cleaned and reused.

The container reuse system (11) is for allowing reuse of a container (15) in a cleaned state, by having the system including a container (15) formed and configured to be able to be readily cleaned and reused, a cleaning device (21) configured to be able to readily clean the container (15), and a controller (31) configured to control the cleaning device (21) to enable the container (15) to be readily cleaned and reused.

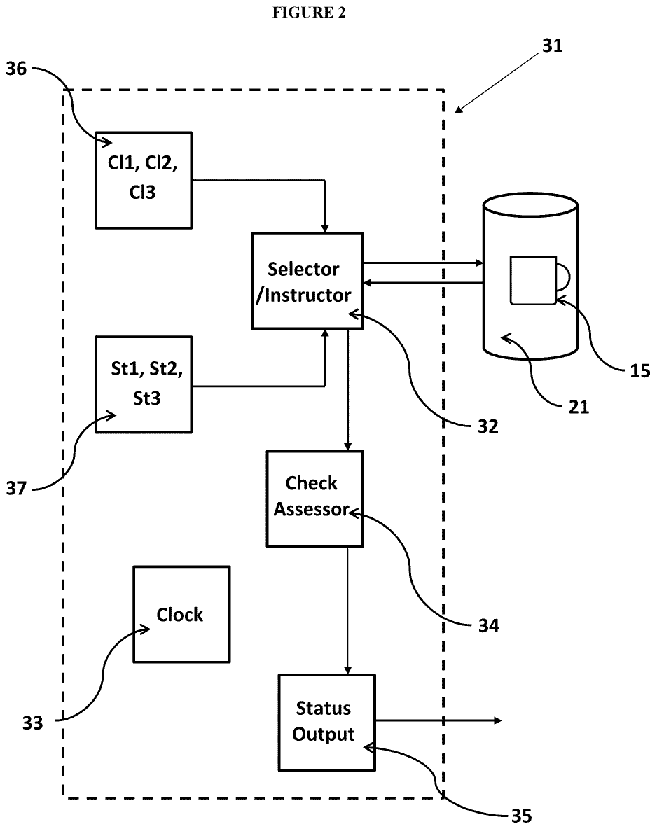

As shown in FIG. 2 the reuse-controlled system includes a controller (31) for controlling the cleaning apparatus (21) for controlled cleaning and thereby reuse of containers (15). The controller coordinates with the container to provide a defined cleaning process and transfers data regarding the clean process to the container which can be read at a reuse station. The controller includes a clock for identifying the time of cleaning and extent of cleaning and transfers data regarding the cleaning process to the container which can be read at a reuse station.

The controller (31) has a selector/instructor (32) for receiving instructions of the required cleaning instructions. This cleaning instruction can come directly from a remote store connection or be predetermined according to the type of container (15) typically being reused. However, most preferably the instruction is received from the container (15) itself having an RFID or NFC or other wireless or capacitance communication.

The choice of cleaning instruction can be a defined standard (36) such as C11, C12, or C13 which are predefined standards for food containers that meet known standards such as with or without chlorine, high temperature, quick drying etc. However, the cleaning instruction can be a store defined cleaning requirement (37) such as St1, St2, or St3.

The selector/instructor (32) will control the cleaning device according to the selected cleaning instruction (36, 37) associated with the particular identified container (15) and undertake the cleaning cycle. The check assessor (34) will check that the cleaning procedure has been undertaken and provide through the status output (35) an output of the clean status and the time stamp according to the clock (33) so that the true clean status of the container is known and determined suitable for reuse.

The system provides a cleaning device (21) enabling cleaning of a particular container (15) separately and upon receiving a required cleaning instruction regarding a particular received container and undertaking the cleaning instruction regarding the particular received container. An output is provided showing the particular received container has undertaken the required cleaning as instructed and thereby undertake a reuse of the received container has been shown to have undertaken the required cleaning as instructed.

A particular benefit of the system is that there is communication between a cleaning station and a reuse station. This communication can be by the container itself that is being cleaned.

The cleaning station can undertake a cleaning program as determined or acceptable by the reuse station and the selector (32) will control the cleaning device according to the determined or acceptable cleaning cycle. The check assessor (34) will check that the cleaning procedure has been undertaken and provide through the status output (35) an output of the clean status and the time stamp according to the clock (33) so that the true clean status of the container is known and determined suitable for reuse. This status is transmittable from the cleaning station to the reuse station.

Therefore, a shopping center or university hallway could have a free-standing cleaning station which undertakes the cleaning of the container. This clean cycle and timing are then recorded in the container RFID or NFC or other wireless or capacitance communication. The container is taken to the coffee shop for a coffee refill or university campus food hall for refill of food. However, first the coffee or food provider can interrogate the container to see what cleaning cycle was undertaken and when and whether it meets their requirements for reuse. This could mean that certain types of cleaning are required or that a cleaning must have occurred within the last thirty minutes. This means the container can be verified to meet the vendor's hygiene control levels, even though they did not undertake the cleaning themselves, and can be reused without any problems of affecting their food or drink being vended.

### Container

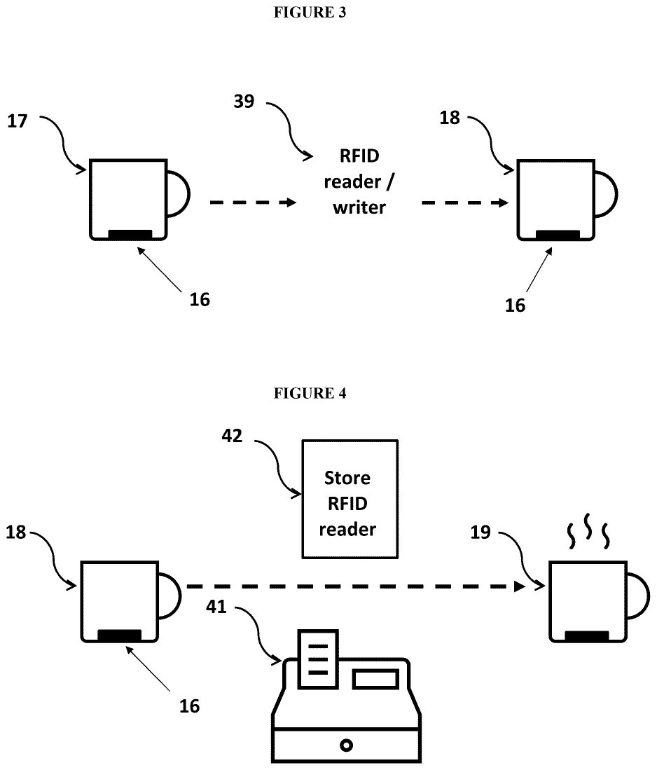

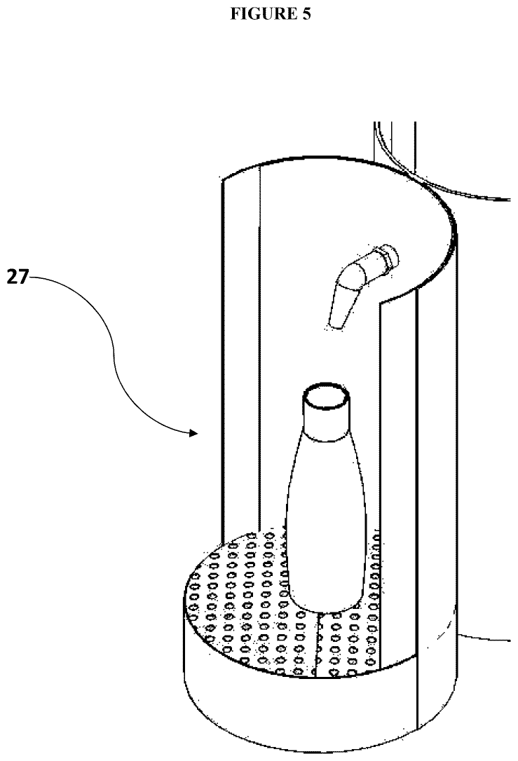

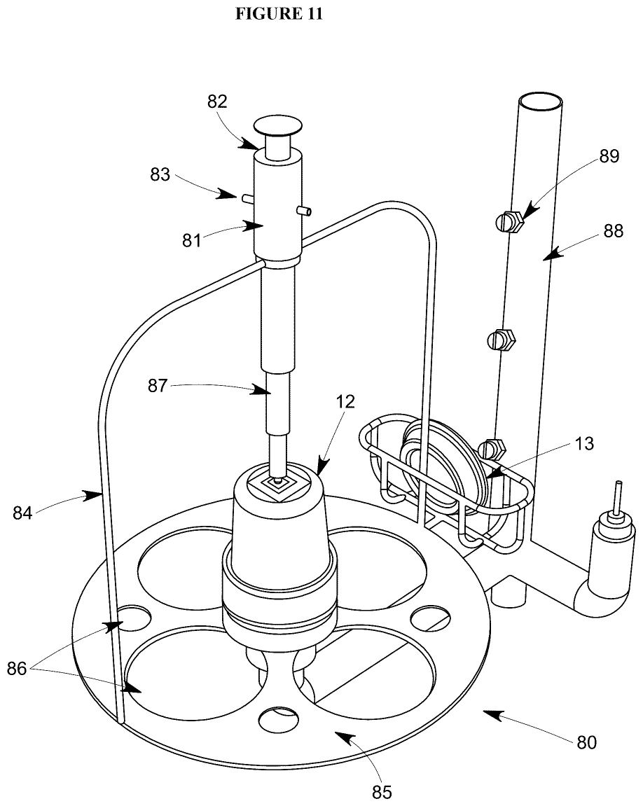

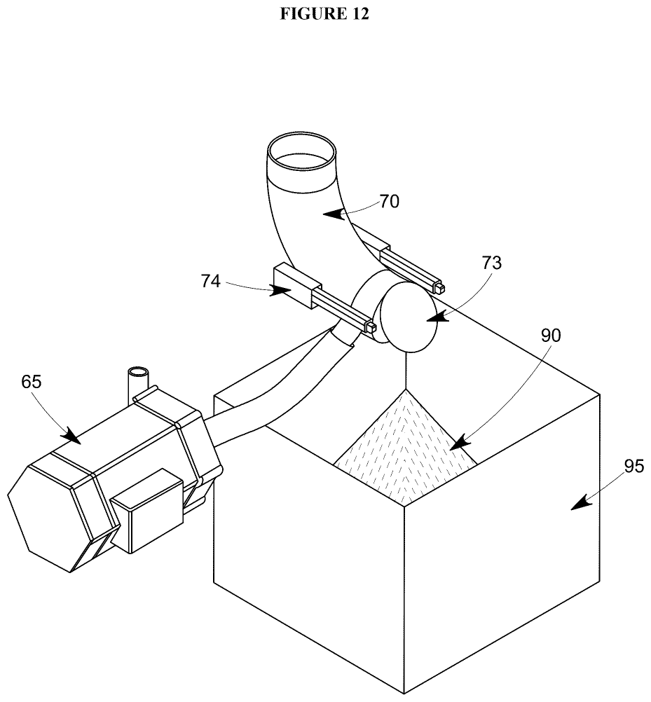

As shown in FIGS. 3 and 4, a container (17) to be used in the reuse system needs to be a food quality recleanable material such as food quality plastic, food quality glass or food quality stainless steel. However, a container includes bottles such as shown in FIG. 5 or cups (12) with lids (13) as shown in FIGS. 10 and 11. It also can include other containers such as takeaway food containers that can be mounted and held in position on the tray.

Preferably the container (17) is formed of glass that can be reused many times so as to maximize the benefit of the reuse system. Preferably the container is formed of recyclable glass and not recyclable plastic. While recycling plastic is helpful, it is not a long-term solution. Not all plastic is recyclable. Recyclable plastics can only be recycled to a limited extent due to their material properties, waste processes and chemical safety.

Some glass can be infinitely recycled without ever losing its quality. Not all glass can be recycled. This is why the system will preferably only be made with high quality double wall glass.

Another particular benefit of glass is that optical sensors can be readily used to determine the material, determine any degradation or faults in the material and more readily allow assessment of the effectiveness of the cleaning on the container. Still further certain glasses are able to take heat treatment without ill effect and therefore allow a wider range of cleaning techniques without degradation.

### Cleaning Instructions

The cleaning device includes a compartment associated with at least one cleaning mechanism for receiving the container to be cleaned. The cleaning compartment of the cleaning device (21) is connected to a supply of cleaning elements including water, heat and chemicals (being chlorinates if to be used or including non-chlorinate green chemicals if an environmentally friendly cleaning process is required).

At least one sensor device is for sensing the container and undertaking the controlled cleaning procedure on the container. The cleaning process can be undertaken in a time period of less than three times the time period for reusing the container. For example, the cleaning process of a container for drinking coffee can be undertaken in a time period of less than three times the time period for making a barista quality coffee in the reused container.

The control system for controlling the cleaning process receives a selected cleaning process and controls the determined cleaning procedure on the container.

The controller receives the required cleaning procedure to be undertaken on the container from a remote source and controls and instructs the cleaning device according to the required cleaning procedure.

The cleaning device is connected with the controller and receives the required cleaning instruction automatically from a store according to their requirements.

The controller receives the required cleaning instruction from automatic receipt of instruction by a sensor device interacting with a device on or in the container providing the required cleaning procedure to be undertaken on the container. The sensor device interacts with an RFID device on the container for reading a status and required cleaning instruction.

The required cleaning instructions can include a predetermined combination of one or more of:
with or without chemicals;
with hot water at a high range;
with hot water at a medium range;
with or without chlorine;
with a predetermined time period;
with drip dry; and
with high heat drying.

### Status

The cleaning device has a device for transmitting the cleaning status of each user-particular container provided to the output port is an RFID/NFC writer for writing to an RFID device on the container for carrying a status with the container. At least one device is for transmitting cleaning status of each user-particular container provided to the access port; and for receiving by at least one device for transmitting cleaning status for allowing identification of status of the respective confirmed container for at least one of each user.

The status associated with the container includes one or more of:
(a) cleaning procedure undertaken;
(b) time of cleaning procedure;
(c) location of cleaning;
(d) number of lifetime cleanings; and
(e) assessment of container quality.

### Standalone

For best effect the cleaning is undertaken at a cleaning device comprising a controlled standalone system to individually wash, rinse, sanitize and dry single food containers, with lids, of no more than 5-liter capacity. This standalone system can be in open public spaces and preferably at or near retail outlets that will reuse the clean containers.

The controlled standalone system can include one or more of:
(a) freshwater storage tank;
(b) wastewater storage tank;
(c) liquid drink dispenser;
(d) ice dispenser;
(e) solar panels and associated batteries;
(f) LCD or similar display screen for advertising or information messages; and
(g) water filters and/or water electrolysis system.

A container reuse system can include an API to manage and control said features and operation.

Within the confines of the apparatus a drink dispensing system can be incorporated allowing customers to refill their cleaned and sanitized bottles. As both straw and teat as well as the bottle have been cleaned, access to safe drinks dispensing is made available. The system can incorporate most types of dispensing systems.

Typically, drinks are sold in plastic bottles. Said bottles need to be distributed, refrigerated and recycled. By incorporating a drinks dispenser in the cleaning apparatus, the need for separate bottles, refrigeration and associated recycling issues are eliminated.

A combination of bottle washer and drinks dispenser eliminating the need for separate drink bottles.

The apparatus can be stand alone or installed in multiple bench top/inbuilt modules, especially efficient for fast food outlets.

### Cleaning Device Structure

The system uses a stainless steel structure either round or square with removable panels for access. The frame is designed to be adjustable, and easily changeable to allow growth with the product itself. The frame was made from Stainless steel, allowing durability, and providing a weldable surface. Rear vertical plate is designed to hold electrical components, without water infiltrating and causing damage.

The container reuse system has a container receiving device which is mountable within the cleaning device by at least one pivot point for allowing spinning of the container receiving device.

The new wash platform is designed with a new gear motor installed. The new gear motor provides a greater range of speeds. The wash platform can be driven via a belt to assist in the general safe usage.

The new wash platform features an interlocking system at the top, allowing platforms to be interchanged and flexible to all various needs. To hold the container, a bar was fitted to slide on the supports. Once the container is placed on the platform, the bar is lowered, the weight prevents the container from sliding out while spinning. A basket is welded on to the side, for the caps and lids.

Referring to the embodiment of FIG. 11, the wash platform of the system has a container receiving station formed and configured to be able to receive a container (12, 13) to be cleaned, mounted on a container receiving device (80) that is removably insertable in the container receiving station.

The container receiving device (80) has a vertical spinning arm (81) held at a top mount (82) and locked in position by outwardly protruding ears (83). An inverted U-shaped frame (84) is mounted on the spinning arm (81) and holds a frame base (85) having access holes (86) to allow cleaning fluid to be able to approach and clean containers mounted on the frame base (85). A telescopic arm (87) extends coaxially to and from the spinning arm to resiliently hold the container in place on the base frame (85) as the container receiving device spins by the driving of the spinning arm (81).

The container receiving station has a cleaning device including water channels (88) alongside and underneath and waterjets (89) positioned along the water channels and cooperating with the container receiving station (80) and configured to clean the container (12, 13) in the container receiving station.

The container receiving device rotates at a low rate allowing liquid to be received on a container and parts in the container receiving device and rotates at a high rate allowing liquid on the container and parts in the container receiving device to be removed by centrifugal forces.

The cleaning device includes a liquid circulation system including a liquid retention chamber able to receive the container receiving station, a liquid feed into the liquid retention chamber to wash or rinse the container and parts in the container receiving device and a purge system for selectively exiting liquid and solids from the liquid retention chamber wherein solids in a container to be cleaned or rinsed can first be purged of solids.

Rinse arms added given the difficulty of creating one arm to do both wash and rinse, upgraded wash arms to allow for the flow we required, both fixed via welding to the frame.

2× solenoids are added, one to fill tank, and one to supply rinse directly. A tank is used as a supply for the wash pump. 2× float switches are added, one to indicate high water level and one to indicate low. A drain valve is added. With all these additions, PLC program was updated to allow a full cycle to be run, with a partial drain feature, allowing room for the clean rinse water to be added to the tank. The cycle is triggered by a switch.

Referring to FIGS. 10, 12, and 13 the curved tank or sump (70) includes a hinging mechanism. It uses 2× miniature actuators (74) to open the door (73) entirely allowing full drainage through the exit (72). A sheet of rubber is siliconed to the door allowing the water to hold when closed. A pump (64) is connected to the side of the tank (70).

The unit is controlled by means of a PLC. Program start can be either via a start switch, door switch or RFID housed within the RFID. Within the stainless steel structure is a watertight wash cabinet that houses a turntable, a series of stationary air and water nozzles and an open-ended wash tank which can be closed by means of the actuators. The lower end (72) of the wash tank (70) opens up over an external waste filter basket (90) in the shape of a pyramid. The pyramid shape of the waste basket is to increase surface area thus minimizing blockage and overflow while allowing fluid flow for greater recirculation. Further the bulk waste can build up on the pyramid filter (90) and allow for maintenance to be needed only after long periods. Further the recovery of the water is used in the purge cycle of the next usage and therefore overcomes the problem of cleaning cycle using water that passes over refuse as occurs in normal dishwashers. This means a quicker, more efficient, and higher quality clean and rinse occurs.

The stainless steel structure may contain a rage replenishment system (27) such as shown in FIG. 1 and FIG. 5 that can use the clean water from the tanks that provide clean water to the cleaning system. Also, the standalone system can incorporate advertising screens. Access to the wash chamber (26) is by means of manual or automatic door.

A functional part of the system unit consists of two hot water holding tanks with integrated heating elements. These tanks are refilled by means of electric or pneumatic solenoid valves.

Water level maximum and minimum are controlled by means of levels sensors.

Temperature is electronically controlled via the PLC. The tanks are connected to a series of motorized valves and pumps all of which are controlled via the PLC.

The cleaning device part of the container reuse system includes:
(a) improved wash tank with water sump having openable end gate;
(b) flush system from water sump through openable end gate to pyramid filter;
(c) a removable wash platform for holding different containers;
(d) water supply from first tank to the wash platform;
(e) spin mount of the wash platform for washing;
(f) capture of wash in water sump by closed end gate;
(g) recircling of wash water to the second tank; and
(h) spin mount of the wash platform for centrifugal drying.

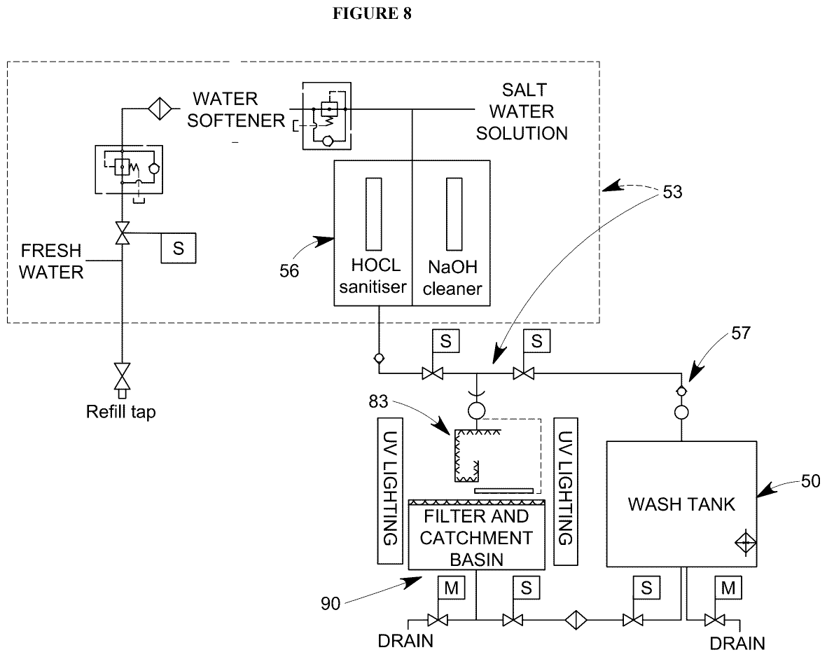

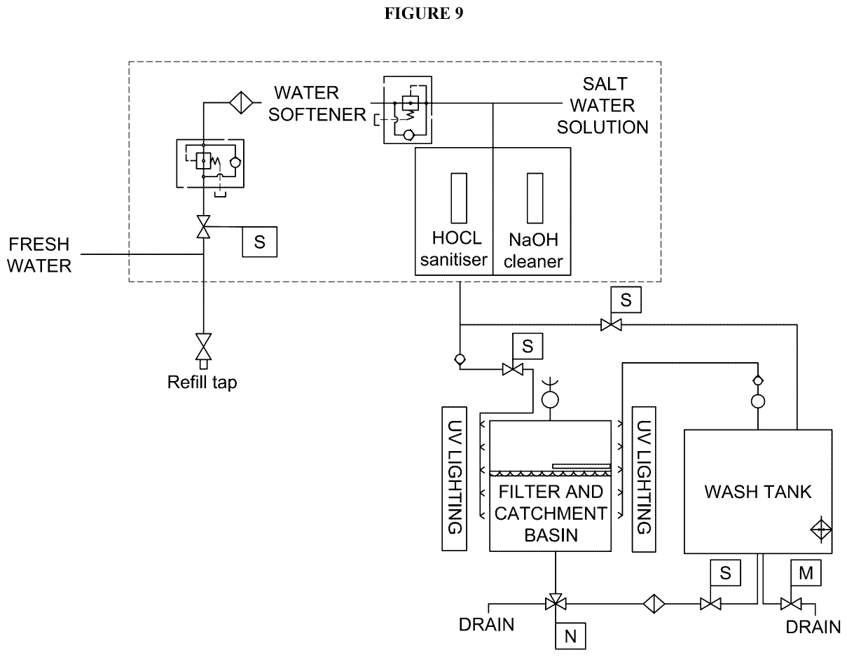

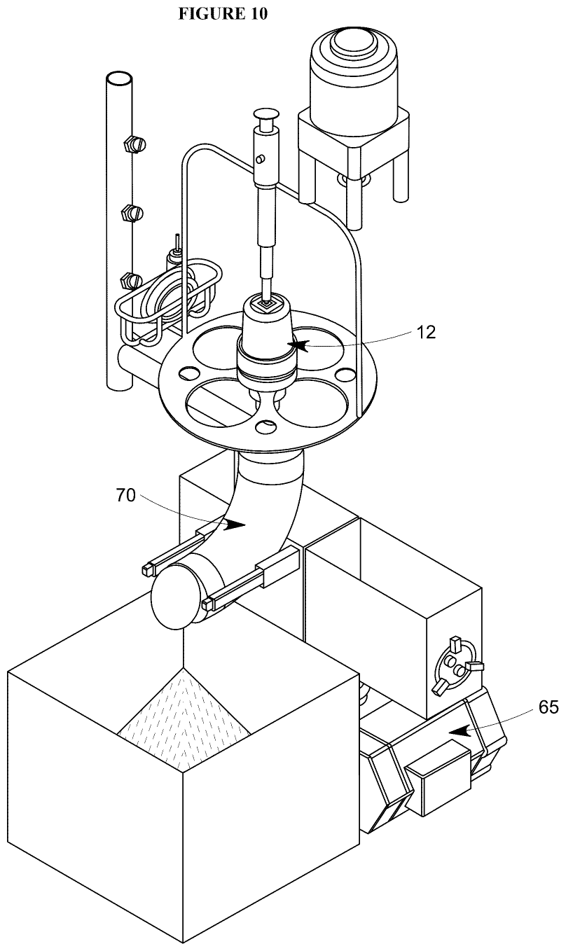

Referring to the embodiment of FIG. 8 or 9, the wash chamber has a rotating central platform which is connected to drive motor DM-1. Drive motor DM-1 turns the platform during the wash cycle at a slow speed (about 5-15 RPM) and during dry cycle at up to 200 RPM. An extraction fan F-1 will operate during the dry cycle to remove excess moisture from the wash chamber and assist with drying. During and after the entire cycle UV light (UV-1) can operate to assist with bacteria control.

The wash manifold will consist of a central nozzle to clean the interior of the container; side nozzle(s) to clean the exterior of the container as well as the lid and possible teat. A dedicated nozzle is fitted to clean straws. All nozzles are fixed to suit maximum performance. A pressure switch PP will monitor pressure in the manifold. Too low can mean no water, too high can mean blockage.

Wash platform speed includes wash (minimum 20 RPM) and dry (minimum 300 RPM). The wash speed allows proper coverage over minimal time, while still having effective contact time. The dry speed was found to be dependent on the container itself, but the general minimum requirement to remove the majority of water was 300 RPM.

Mesh aperture varies from top to bottom to allow better flow of water and minimize waste in the drain system. Aperture will range from 3-6 mm based on soil levels from a standard dishwasher.

Nozzle size can be 20° 5.81 Lpm (at 3 bar) flat fan nozzles set up for external wash and rinse, and a custom direct injection nozzle for straws and internal wash/rinse. To allow flexibility for various system set ups, this may change based on container style/platform design.

### Process Steps

The cleaning device part of the container reuse system includes process steps which are novel separately or at least in combination. These steps include:
(a) purge cycle;
(b) external filtering;
(c) spin washing/drying; and
(d) water cycle reuse.

### Purge Cycle

In the purge cycle there are a number of inventive elements that are used in various combinations to provide a range of synergistic benefits. These elements include:
(i) openable tank (70);
(ii) angle of curved tank angle;
(iii) side access pump (64); and
(iv) Pulsing of pump.

Removing solid debris from containers before washing is one of the major issues when cleaning. Manual removal is one option other methods have been to use water. The issue with using water is exactly that: using water. Water is still required for cleaning and debris removal, however, is larger soil residues can be removed first cleaning would be more efficient and environmentally friendly. The system uses a blast of air to remove loose impediments from a container followed by a purge cycle and then a washing and rinsing phases. The air blast will dislodge debris, and the purge phase will flush it away along with liquid debris.

In the purge cycle the system includes a refuse system having an openable sump for allowing flushing of refuse in a first action, a pump for drawing liquid and solids into the sump, a filter for allowing substantial separation of liquids and solids and a rubbish trap for retaining separated solids while allowing passage of liquids back to the liquid recirculation system. The openable sump includes a curved direct pipe, and the pump is offset to the pipe to allow clear unhindered flow to the filter and rubbish trap when the openable sump is open. Curved Tank Angle: 90<θ<160.

To develop the low water usage concept, a filter in a tank was repurposed as a sump leading to an external filter to experiment with the minimum amount of water required to use the wash pump. This was found to be highly successful and a major diversion from usual systems. While water usage was very low, given the design of the “sump” and the pump attached to the side to draw the water and refuse through the sump, the water created a vortex when water was at a minimum. This vortex was not wanted as it meant that air could enter the pump and cause catastrophic damage to the pump. Therefore, this appeared to prevent the water from being tested at even lower levels.

To solve the vortexing problem, the tank was designed using a 90° elbow sump. This design reduces the vortex itself and its impact on the system. Through testing, we found the actual shape of the sump to be very successful, however the drain as indicated above, would be too easy to clog with items such as tea bags, fruit peels etc.

Through the assumption that tea bags and large waste items will be put into this final machine, the original filter concept was deemed unsuitable. The idea of having a full purge cycle with an ability to fully remove the large waste items from the wash chamber allowed the creation of the next concept tank. Instead of a small drain point, the entire base of the tank will open on to a pyramid style filter. This will allow the wash chamber to remain clean, the waste to be removed from the wash section.

To solve both issues the curvature of the sump was the best method to reduce a vortex. An angle between 90° and 160° allows that vortex reduction, and also allows enough flow for the waste, such as teabags, and dirt to be removed.

Water usage can be further reduced by using a small air compressor, or bursts of air through a series of strategically placed nozzles should assist in removing dirt and debris from the containers prior to the purge cycle. In having this air system set up, it will also be helpful in the drying phase, to remove excess water in crevices.

### External Filtering

In the external filtering the filter is a pyramidal filter whereby solids are able to slide down the greater quantity of the surface area of filter while allowing ready transmission of the liquids. The rubbish trap with the pyramidal filter can allow solids to accumulate but still allow water flow for the wash cycles and thereby can be emptied at maintenance periods rather than each wash cycle.

### Spin Washing/Drying

The system is based on washing a single container on a rotating table that is subject to water jets from all angles and subsequent increase of rotational speed allowing for water to be dispersed by means of centrifugal force. An inbuilt chip determines the type of food ware container and thus the required spin time. In the Spin washing/drying clearly the wash supply to the wash platform and the spin mount of the wash platform for washing.

Washing takes place on a removable rotating platform. At cycle's end this platform will increase in speed thus centrifuging excess water from all crevices eliminating the need for hot jet air blow drying. The spin mount of the wash is at low rotational rate so as to allow liquid to be used to wash the container. In contrast the spin mount of the wash is at low rotational rate so as to allow liquid to be used to wash the container.

Most dishwashers operate by having revolving arms spray water above and below items placed in washing racks. The rotational speed of these wash arms can vary from 60 to 90 RPM. Many parts of items to be washed are not directly hit by the jets of water and rely on secondary flow action for cleaning.

Our system can in one form have a fixed arm outside and a fixed jet inside the items to be cleaned. The item rotates on a table at fixed revolutions thus ensuring all parts are directly contacted by the water jets. Straws are placed directly over a jet spray water into the straw. This improves washing efficacy.

It should be noted that an important element is that the water from the waterjets and the container to be cleaned move relative to each other. This can be by either one moving relative to the other or both moving. It has been found that better control is obtained by the container receiving device being (a) removably mountable, (b) lockable in a vertical rotational axis and (c) drivable at different speeds to allow washing at lower speeds and centrifugal drying at higher speeds. This can be combined with heat or UV or other drying means.

Disposable drinking straws are in many cases recycling unfriendly. Straws are also considered to be a potential health hazard because of the narrow diameter they are difficult to clean. The water jets from dishwashers cannot properly penetrate. In some cases, brushes are used. However, the problem with brushes is that if they are not cleaned properly, they themselves become a breeding ground for bacteria. The system consists of a narrow pipe connected to the wash manifold over which the straw is placed. Wash and rinse water are injected through the internal part of the straw thus cleaning and sanitizing it.

### Water Cycle Reuse

In the water cycle reuse the container reuse system has a cleaning device including a liquid circulation system. This comprises a liquid retention chamber able to receive the container receiving station and retain liquid or solids therein, a liquid feed into the liquid retention chamber to wash or rinse the container and parts in the container receiving device, and an openable sump for selectively exiting liquid or solids from the liquid retention chamber.

The liquid circulation system includes a connection to a first tank and a second tank wherein clean liquid can be fed to the first tank and purged water from the openable sump can be fed to the second tank wherein the water from second tank can be reused in a step of the cleaning process.

To save on water consumption the rinse water from the previous cycle is pumped into a holding tank and used for the next purge and wash cycle. This also allows sufficient time for the first holding tank to heat to the required temperature.

### In Use

It can be seen that the system has a cleaning device including a wash chamber with rotating shelf, automatic door and UV lighting, a receiver for receiving containers with imbedded devices to start and record wash, rinse, sanitize and dry cycles as well as such information that is required to assure set cleaning and sanitizing protocols have been met and a self-cleaning cycle and filter for system to individually wash, rinse, sanitize and dry single personal containers, with lids, of no more than 5-liter capacity. The cleaning device includes one or more cleaning mechanisms selected from physical scraping, jet flow, chemical treating, oxidizing or heat treating.

In use as shown in FIGS. 3, 4, and 10, the container reuse system includes the steps of providing a container (15) having a status carrying an RFID device (16). This device carries the status of the container including, but not limited to, cleaning procedure undertaken, time of cleaning procedure, location of cleaning, number of lifetime cleaning, assessment of container quality, etc.

By identification of the container by the RFID reader/writer (39) reading the RFID (16) of the container it is determined that the container (15) is an unclean container (17) and that because it is associated with a particular store is to receive a required cleaning instruction related to the identified container.

By undertaking the cleaning according to the required cleaning instruction related to the identified container the RFID reader/writer (39) can update the status of container to a cleaned container (18) that has fulfilled the required cleaning process. There can be a time stamp provided by the clock as being cleaned within the last hour is acceptable but being cleaned yesterday might not be due to the chance of recontamination over an extended period of time.

With the updated status to a clean container status (18) in the recorded status of the RFID device (16) in the container, the user can present the clean status container (18) as shown in FIG. 4 by the status of the store RFID device (42) at the store point of sale device (41) so that the cleaned container (18) can become a reused container (19).

Our invention differs from stand washing machine methods in that processing time is based on intended use and can be individually programmed to suit each use because a chip built into the container to be cleaned will automatically set the correct program for best cleaning efficacy. Drying relies on centrifugal force and not heat or thermal shock by spinning the item water is forced off and out of cavities. Using less water results in less chance of bacteria growth.

The system is designed to wash and rinse individual items with:
a rotating washing platform allows better coverage by direct waterjets;
straws and very narrow containers are placed on individual;
our rotating platform is removable, allowing different configurations to clean different items:
   straw platform washing only straws;
   bottle platform washing only bottles; and/or
   general purpose platform to wash mixture of containers.

### Example 1

The washer consists of a straight or curved wash sump (70) below the wash frame (80) that holds the container (12) and with the water and detergent supply through the water channels (88) form the wash compartment. The lower or angle end of the wash sump (70) sits over a filter basket (90) and via an opening tail piece forms a gate (73). The tail piece or gate (73) is monitored by sensors for controlling open purge position and closed wash or rinse position.

The lower end of sump (70) is about 30 mm above the lowest point (3) is connected through an inline filter and three-way valve to a circulation pump (4) which in turn is connected to a 3-way valve (5). Valve (5) is connected to a manifold of wash jets on one side (6) and an insulated tank (7) on the other. Tank (7) is heated and connected to drain via valve (11).

Tank (8) is heated and connected to booster pump (10) which in turn is connected to 3-way valve (9). Pump (10) is connected to manifold (6) via nonreturn valve (14).

Tank (1) is connected to a detergent (12) and sanitizer pump (13). Valve (A) and (B) are tank (7) and tank (8) water fill valves.

At cycle rest tail piece (2) is open; valve (5) is open 1-2 and valve (11) is closed. Tanks (1 and 6) are empty. Valve (9) is open 1-2.

### Stand-By

Initially tanks (7, 8) will fill with water and be heated to the required temperature. Filling, heating, level control is automatic. If not used for a set period of time, or after 3 hours of use, pump (10) will activate, valve (9) will open 1-2 allow water to be flushed via manifold (6) to drain. This is the self-cleaning cycle.

### Cycle Activation

User places container near System door which is activated by RFID/chip in container. Sensor monitors and once hand is removed from chamber door closes and chosen cycle starts.

### Purge Cycle

Cycle start hot water is fed from heated tank (8) via pump (10) and valve (9) 1-2 through manifold (6). Tail piece (2) is open, and water/debris is purged straight into drain. After 2-3 seconds (or set time) tail piece (2) closes thus ensuring any debris is removed. The wash chamber table rotates at approx. 10 RPM.

### Wash Cycle

Once tank (1) has reached set level valve (9) closes and pump (10) stops. Valve (5) is open 1-2 and pump (4) starts for a set time. Pump (12) adds detergent to wash tank (1). Water circulates for wash program duration (40 seconds). A pressure sensor notices no or little pressure (tail piece [2] open?) or too much pressure manifold jets (5) blocked.

Pump (4) stops, and tail piece (2) opens allowing water to drain.

Rinse cycle. Pump (10) takes water from tank (8) and distributes via manifold. Valve (9) in position 1-2. Tail piece (2) is closed. A sanitizer (13) is injected to suit program.

After the set rinse time, pump (10) stops. Valve (5) opens 1-3, centrifugal pump (4) pumps water into tank (7).

The rotating table is the wash chamber increases revolutions to approx. 60 rpm thus centrifuging water off the container while blowing ambient air. Cycle is completed. Tail piece (2) opens. During the spin cycle a fan will remove moist air from the wash chamber and disperse to reduce heat load. Door opens.

The inline filter is automatically cleaned either at set intervals or when pressure sensor P detects lower pressure indicating blocked flow of water; the reason could be a blocked filter. If water is not used for a set period of time (depending on health requirements) valve (11) opens and water is pumped reverse through inline filter to drain. Flap is open. is drained. If a new cycle starts before the lapse of time, then at the start of a new cycle, then valve (9) opens, and tank (1) is filled with water from tank (7). Valve (9) opens 2-3. Tail piece (2) is open for a few seconds then closes (purge cycle). When the tank is full cycle commences as normal wash cycle.

The entire wash chamber is lit by a UV light to minimize bacteria growth during nonoperational periods.

The pressure sensor in manifold line measures high and low pressure. High pressure may indicate blocked nozzles which require technical assistance. Low pressure may indicate blocked filter, water leak, no water.

This saves water as the used fresh rinse water is used for the next washing.

The purge cycle is intended to remove soil before the wash cycle starts and to minimize contamination of wash water by purging the container.

Tank (1) has an angled base with a drain connection tail piece (2) at the lowest point. About 30 mm above the lowest point a connection is made for pump (4).

Tank (8) is a heater tank that contains potable water and is heated to at least 75 °C. Tank (7) is also heated.

### Example 2: Wash System

Example 2 was conducted under the following conditions:
(a) General Operation:
   (i) Wash tank fills and heats
   (ii) E-water tank fills with the acidic electrolyzed water (sanitizer)
   (iii) Customer Scans the bottom of their product, sliding door opens and allows product to be placed on rack
   (iv) Door (end gate) closes
   (v) Wash water is sprayed through both a rotating blade and a static blade
   (vi) Wash water is collected in the catchment basin
   (vii) Wash water is filtered and recycled to wash tank
   (viii) Rinse sanitizer is then sprayed through the same rotating and static blades
   (ix) Auto scraper process occurs
   (x) Sanitizer is recycled to the wash tank
   (xi) Door (end gate) open, product RFID has been updated with wash information
   (xii) Customer removes their product, door closes
(b) Side Notes:
   (i) Wash water is dumped after a set amount of time
   (ii) Sanitizer is always made with freshwater
   (iii) UV lighting used for antibacterial purposes
   (iv) IoT used to monitor machines, services, customer usage, general data
   (v) Display screens to entertain, interact with while you wait
(c) Auto Scraper Process:
   (i) “Scraper” is attached to the base of the rotating blade, spinning while the wash/rinse process occurs
   (ii) The dirt is collected in a thin line in the same position at the end of each cycle
   (iii) A small water jet pushes the dirt into the bin off the side of the wash station
   (iv) Bin is removable to allow easy cleaning
   (v) Water is further filtered after collected in catchment basin
(d) Washing Status

The system will also alert when service or maintenance is required. This can be on a time or use basis. The cleaning will consist of a recirculated wash, or if local requirements demand a wash and dump. The wash is carried out similarly to a dishwasher to ensure removal of soil. The cleaning wash is followed by a sanitizing freshwater rinse that will contain a suitable sanitizer or alternatively electrolyzed water. This rinse water may be dumped to waste or used to top up and rejuvenate wash water.

The module can be connected to potable water or an incorporated storage tank for both fresh and used water. Power will be kept to a minimum and where possible solar panels will store electrical power in batteries.

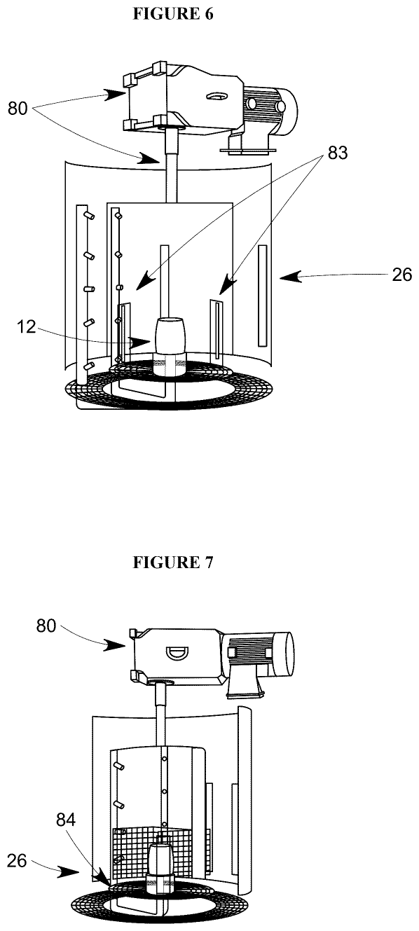

As shown in FIGS. 6 and 11, once a container and its lid are placed inside the wash chamber it will be automatically clamped into position after the door closes.

Water will enter the unit via a solenoid valve to fill a wash water reservoir to a controlled level. This water may or may not be fed via a series of filters depending on the local quality of water. The water will be heated to a predetermined temperature (about 70 °C). A circulation pump is connected to the wash water reservoir and to a set of stationary or rotating wash pipes with spray nozzles inside a wash chamber. The base of the wash chamber is connected via a self-cleaning filter and an automatic valve to the wash water reservoir thus allowing the water to return after it has been sprayed over the inserted container. The container will be washed both inside and out via optimally placed nozzles.

An automatic detergent dispensing device will inject a predetermined amount of alkaline washing detergent to remove soil and stains.

The wash water reservoir is also connected to a waste outlet via an automatic valve or pump. After a predetermined number of washes, or after predetermined time or after a single wash, the reservoir will be automatically emptied. Once empty the reservoir will refill as per the above description.

After the wash cycle freshwater from either an electrolysis unit or with a suitable disinfecting product injected will be sprayed into the wash chamber via a set of stationary or rotating rinse pipes with spray nozzles. The container will be rinsed both inside and out via optimally placed nozzles.

The rinse water will be partially or completely used to replenish the wash water reservoir depending on chosen option (see below). This is controlled by an automatic valve.

During the complete wash and rinse cycle the container will slowly rotate on a plateau or wash plate as shown in FIG. 7 ensuring all sides are covered by the water jets.

At the end of the wash and rinse cycle the plateau will increase in rotational speed allowing for a spin dry action of the containers.

Program cycle status to be displayed. These will be:
(i) Ready;
(ii) In cycle;
(iii) Finished;
(iv) Out of service; and
(v) Self-cleaning cycle, please wait.

At predetermined times when use is minimal, the unit will automatically go into a self-cleaning cycle. The wash water reservoir will drain and refill with water. An extra dose of detergent will be added, and the temperature will be increased to 90 °C. The reservoir drain valve will open and the system will spray this hot detergent water throughout the wash chamber and direct to waste. For additional hygiene a UV lamp will constantly be on in the wash chamber. Wash, rinse cycle times and temperatures to be determined by local governing rules.

### (e) RFID Control

Our invention consists of a number of components which collectively achieve the demands of reducing the environmental impact of supplying food and storage containers.

The food container which can be any type of vessel (with lid) that is suitable to contain food or drink. The vessel will have an NFC/RFID or similar device embedded and assigned to a user. The system can record or start multiple parameters or actions such as:
(1) owner of vessel;
(2) time stamped last cleaning process;
(3) confirmation that the specified cleaning process has taken place according to set parameters;
(4) costs and charging when vessels are refilled;
(5) operation of cleaning and sanitizing apparatus;
(6) marketing data for analysis; and/or
(7) maintenance and repair requirements of the apparatus.

The container will be of suitable food safe and end-of-life recyclable material. It can be made to suit individual retailer designs. Information regarding the container will be accessible to both the user and the retailer.

The software to run and monitor the system. The cleaning and sanitation process can be set to suit local or individual retailers' requirements and embedded in the vessel. An app-based control to suit the operation. The retailer will have a scanner or similar that can read the vessel's data.

A user will take a vessel to a cleaning station. The embedded data unit will activate an access door on the cleaning station. The vessel is inserted. Once the system has detected the vessel and there are no obstructions (hand or incorrect placement) the door will close, and the cleaning program will start.

At the end of the cycle the door will open, and the vessel can be removed. The data will be stored for future retrieval.

### Example 3

The door is constructed from Plexiglas or stainless steel with open/close door operation horizontal or vertical motion and includes a 240 V motor, motor pinion (rack and pinion system) the rack installed at the bottom with guide rails and rolling track to ensure proper linear movement, rollers to ensure smooth movement. The door is designed to open via scanning an RFID/NFC chip.

Once the container is inside and the user is ready, press the start button on screen, user verification code entered (3 attempts, forgot password option) door closes after a countdown of a set time and verification or use the key fob to activate program.

The door has a safety magnet switch integrated with the PLC program. Thereby during operation, the door is locked and cannot be opened. The safety switch is interlocked with code in program to not open during operation and without owner verification.

The door includes a locking piston to avoid tampering/misuse etc. At end of cycle notification signals the machine to request verification code from user, 3 attempts, forgotten password option. If verified, the door opens, the 3D scanner checks for container, if removed machine counts down till closing door.

After a set period, the machine performs a self-cleaning program. During this process the machine follows the same locking process as the wash cycle.

All verification processes and interactive touch options such as start button can be performed via app. If the cycle ends and the user cannot provide verification code after 3 attempts and a forgotten password option, the telescopic arm that is housed next to the wash chamber extends to grip the container, once collected, container placed in storage bin. Via IoT, the owner of the machine, maintenance, and the owner of the cup are notified through online portal, app, etc.

A secondary door is formed of Plexiglas or stainless steel closing vertically or horizontally on rubber seals. Linear motion units are able to raise and lower via guide rails. The purpose is to seal the chamber, prevent splashing the user, water damage to equipment, assist in maintaining cleanliness, etc. The door contains same locking, safety and security mechanisms as primary door, the door will not proceed unless primary door has passed all safety and security checks through PLC program.

A wash chamber is made of stainless steel 304 or molded plastic, no joins, crevices to maintain hygiene with 1× wash blade, 1× rinse blade, and 1× bottle wash arm. Arms are with stainless steel jets with a 60° opening to allow full coverage of containers

The wash blade and rinse blade wash the outside of cups and bottles and wash the outside and inside of containers (containers placed on the side, cups and bottles placed upside down. Bottle wash arm washes inside of cups and bottles). Arms are fixed and a rotating gearbox driven wash table turns the container continuously during the cycle thus ensuring all surfaces are reached by the water jets. After the wet cycle the wash table will increase in speed to centrifugally dry the container with or without assistance from an air blower.

A gear motor is housed at the top of the chamber, and a shaft is attached to two brackets supporting the wash tray. The gear motor is programmed and controlled via PLC, and the number of rotations is set based on machine settings, local regulations, customer preferences and container type. 2× proximity sensors used to control the gear motor stopping position to return to home each time and prevent the brackets from obstructing the user from their container.

The wash tray is a large-spaced mesh sitting directly above the secondary mesh of which is attached to the frame of the machine. Secondary mesh is a finer mesh, to be used as a filter to collect larger debris that may potentially be in the container. A sweeping squeegee/blade style system is used to automatically scrape debris off the secondary mesh. The blade system is attached to the wash tray to allow rotation around the mesh filter during the cycle; debris is collected through the rotation and collected in removable waste bin.

Water is collected during the wash is recycled in the wash basin underneath the filter mesh. Recycled water in the wash basin is coupled with a wash pump which operates during cycle and activated via the PLC program based on the status of the security and safety checks.

Jets are connected to the wash pump via piping. Detergent is auto-dosed to assist in cleaning process. Once the wash cycle is completed, the rinse cycle begins for set time using freshwater at a temperature set based on local regulations, machine settings, customer settings, container type via the PLC program. The rinse cycle uses water from a freshwater reservoir through a separate rinse pump.

After the rinse cycle, the spin cycle begins. This is completed for a set time purely for assisting in the drying process of the product. No washing or rinsing occurs at this time. After the spin cycle, the cup is ready for collection, the user is notified via screen, secondary door and the primary door open after the user is verified.

The wash chamber is illuminated for visual signals and aesthetics:
white for loading;
blue for washing, rinsing, spinning; and
green for unloading.

UV light used to assist in maintaining cleanliness. UV is housed above the chamber and activated once doors are closed. Lighting is controlled via PLC to deactivate once doors are open (loading and unloading process).

### Example 4

This example is shown in FIGS. 10 to 14 are diagrammatic views of parts and details of a particularly preferred embodiment of apparatus for use in a container reuse system for cleaning containers in accordance with the invention.

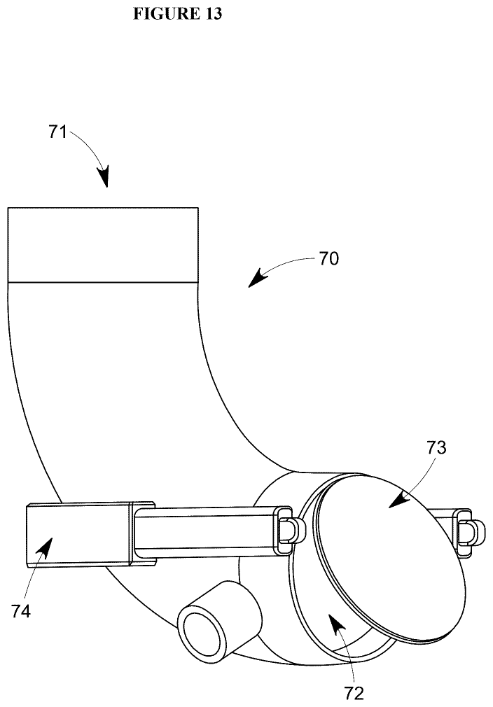

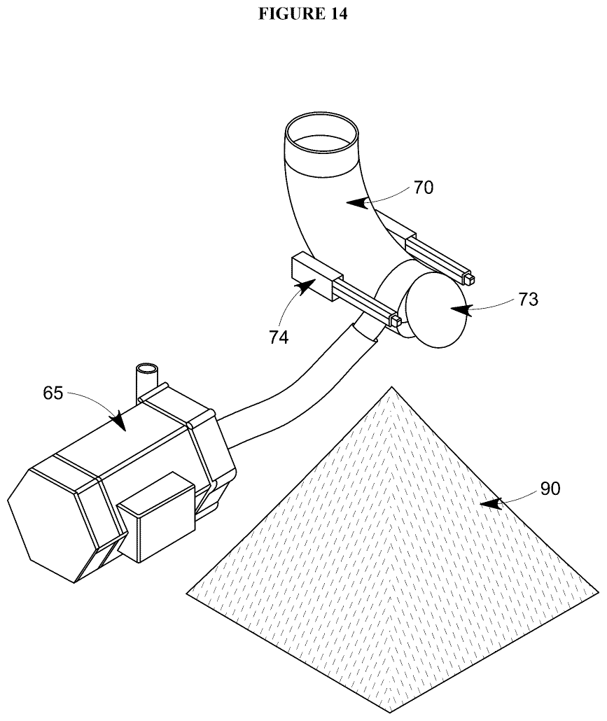

FIG. 10 shows the main components stripped away from the outer housing with details of the washing table (80) in FIG. 11 details of the filtering system (70, 90) (in FIG. 12), detail of the openable sump (70) in FIG. 13 for use as the gravitational and suctional water collector below the washing table (80) and the detail of the pyramid filter (90) and other relative workings of the pump (65) and openable sump (70) in FIG. 14.

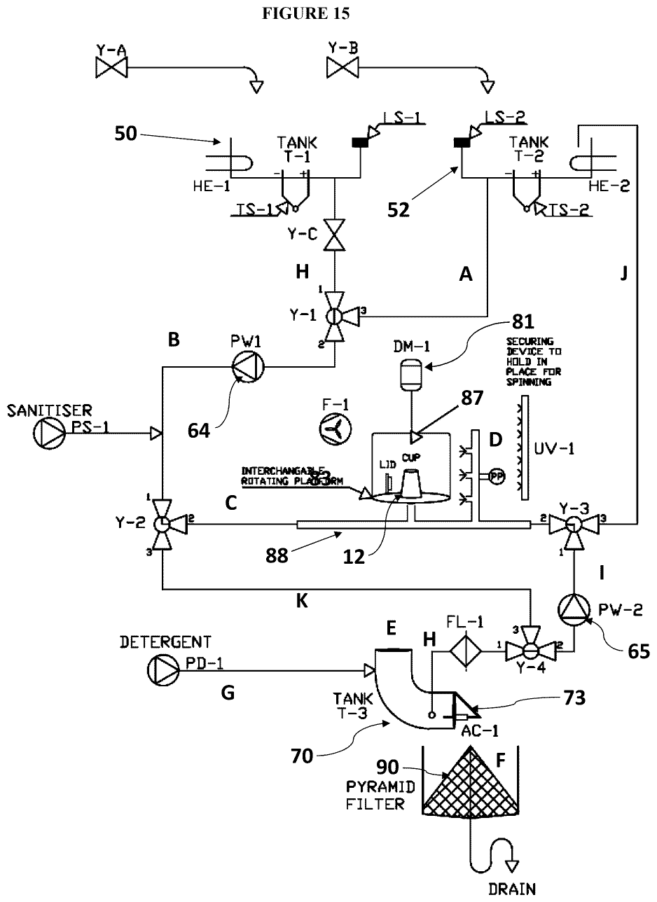

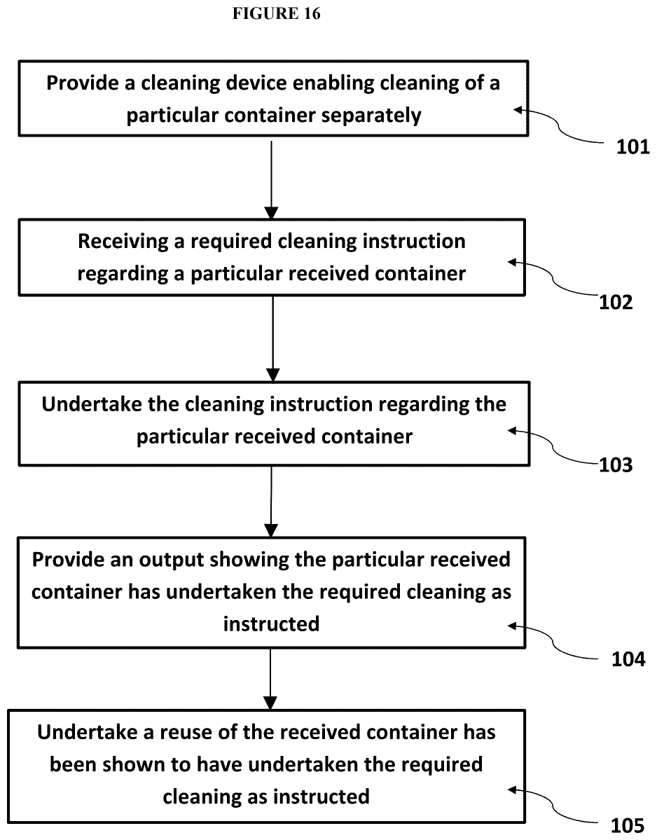

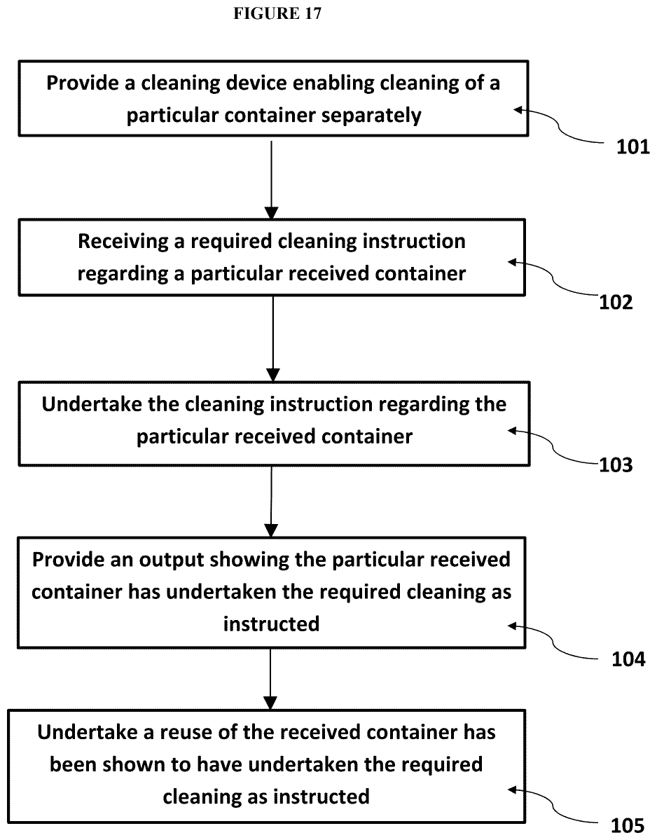

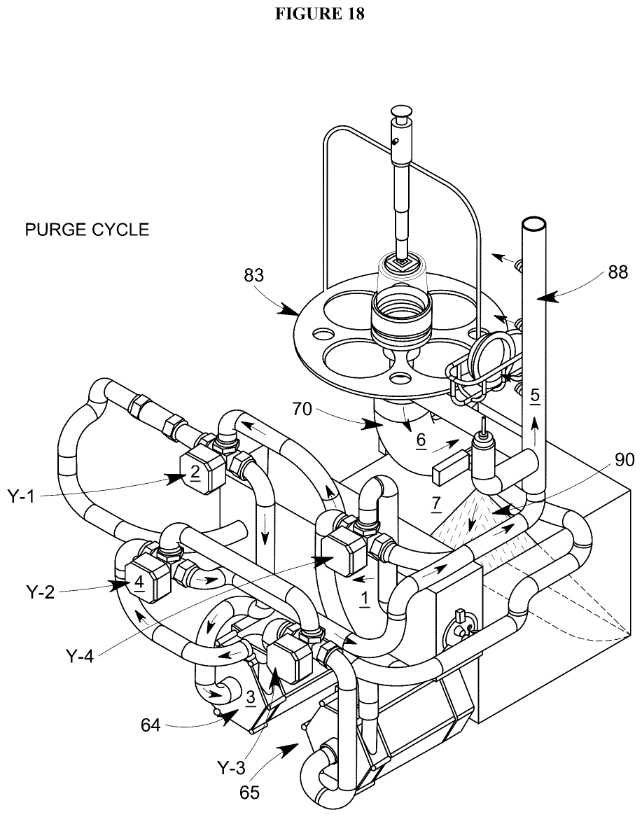

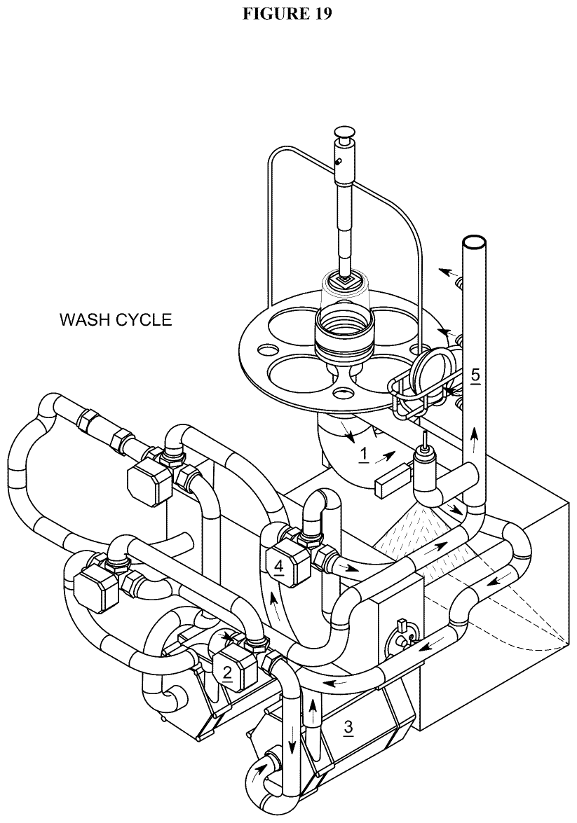

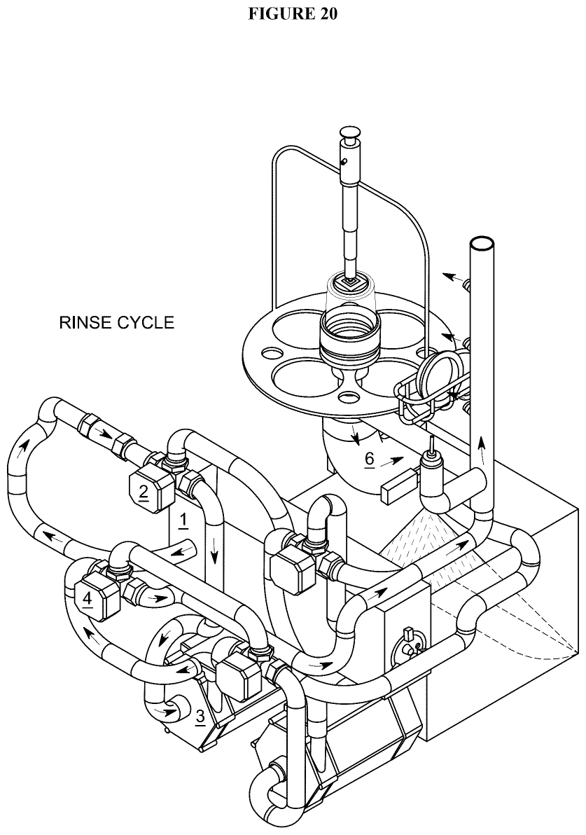

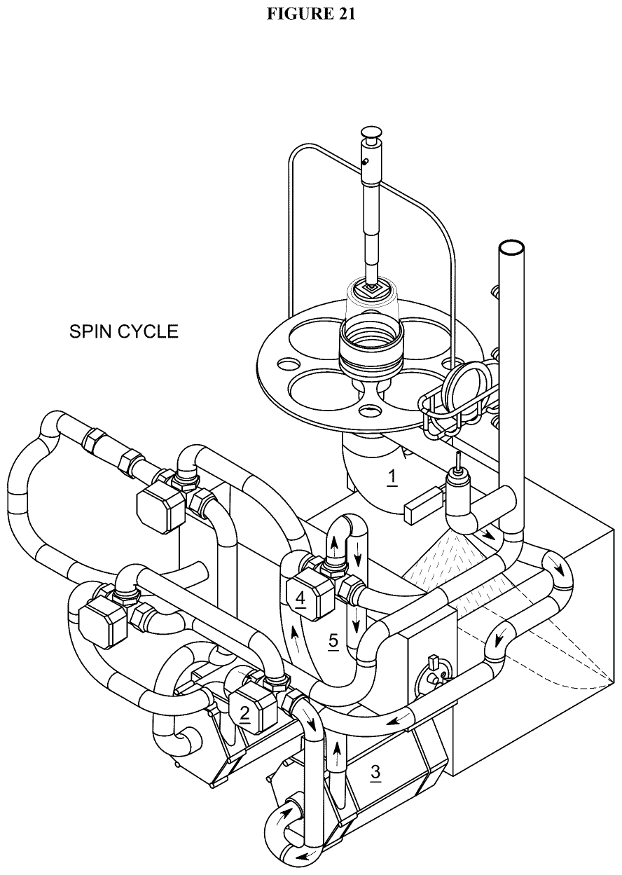

FIG. 15 is a diagrammatic operational view of the container reuse system for cleaning containers showing the operational relationship and defined pathways A, B, C, D, E, F, G, H, I, J, and K.

Referring to FIG. 15, the functional part of the System unit consists of two hot water holding tanks (Tank T-1, Tank T-2) with integrated heating elements (HE-1, HE-2). These tanks are refilled by means of electric or pneumatic solenoid valves (Y-A, Y-B).

The water level maximum and minimum are controlled by means of levels sensors (LS-1, LS-2). Temperature is electronically controlled via temperature sensors (TS-1, TS-2) and the PLC. The tanks are connected to a series of motorized valves and pumps all of which are controlled via the PLC.

When the System is first powered up the PLC will first fill holding tank T-1 by means of solenoid Y-A. Once required maximum level is reached, indicated by level sensor LS-1, heating element HE-1 will heat the water to the required temperature of 70 °C (the actual temperature can be 75 °C to allow for fluctuations). The System unit cannot be used until this initial temperature has been reached.

Once the required temperature has been reached the System unit can be used. Open the wash cabinet door and lift the center bar which is located over the center of the platform. The bar is to keep the cup/bottle from lifting during the wash and spin dry process. Place a cup or bottle, straw and/or teat onto the center of the rotating wash platform. Straws fit to the side as indicated, lids/teats in the designated holder as shown on the diagram. Close the door. The cycle will automatically start within a few seconds. If the door is opened at any time during the cycle, the system will stop and revert to the starting position.

The System has two stainless steel tanks. T-1 (50), the primary tank, is connected to a hot- or cold-water supply via a valve (Y-A). The level in tank T-1 is controlled by a level sensor that switches supply off at high level and supply on at low level. Tank T-1 is heated by means of electric element HE-1. HE-1 switches on when high level is reached and off when either low level is reached or set temperature is reached. Temperature is controlled via PLC and sensor TS-1. At the lowest point tank T-1 is fitted with an automatic valve Y-C. This defines pathway H.

Valve YC is connected to a 3-way motorized valve, Y-1. In normally open position (1/2) Y-1 is connected to wash pump, PW-1. This defines pathway B.

The normally closed position of Y-1 (3) is connected to stainless steel tank T-2 (52). Stainless steel tank T-2 (52) is to catch the used clean final rinse water from a wash cycle, as described below. Tank T-2 also has a heating element (HE-2), a level sensor (LS-2), a temperature sensor TS-1 and a fill valve Y-B.

Tank T-2 is also connected to 3-way valve Y-3 (3) normally closed port. However, when open the water is recycled into tank T-2 (52) to provide a source of recycled water from previous cycle. This defines pathway J.

When there is an open position of Y-1 from tank T-2 (52) and closed position from tank T-1 (50) this defines pathway A and allows the recycled water from tank T-2 to be used (52) instead of further new water from tank T-1 (50).

Wash pump PW-1 (64) is connected to 3-way valve Y-2 (1). The normally open port Y-2 (2) is connected to both the spray nozzle system (88, 89) in the wash chamber (83) as well as 3-way valve Y-3 port 2, normally open. This defines pathway B.

A dosing pump PS-1 injects a preset amount of sanitizer after wash pump PW-1 into the line.

3-way valve Y-2 (3) closed port is connected to closed port (3) of 3-way valve Y-4. This feeds to water channels (88) which form Pathway C and to waterjets (89) which form Pathway D.

Tank T-3 (sump [70]) is open ended. One end is connected to the wash chamber (83) by being at least partially underneath and thereby being gravity connected. This defines Pathway E.

The other end of the open-end sump (70) opens up via an actuator-controlled lid (AC-1) (gate or sump door [73]) over a waste receptacle or filter (90).

A detergent dispensing pump (PD-1) is connected to tank T-3 (70). The filter in the waste receptable is pyramid shaped to allow for larger filter area and therefore cope with more soil before cleaning/emptying is required. When the gate or sump door (73) is open for the large matter residue to drop to the pyramidal filter and the fluids proceed through filter to drain. This is Pathway F.

The lower end of tank T-3 (sump [70]) is connected to an inline filter FL-1 which in turn is connected to a 3-way valve Y-4, port 1. This defines Pathway H.

Three-way valve Y-4 is connected to a second wash pump (PW-2) (65) via normally open port 2. Wash pump PW-2 is connected to port 1 of three-way valve Y-3. This defines Pathway I.

The wash chamber has a rotating central platform (80) which is connected to drive motor DM-1 and spinning arm (81). Drive motor DM-1 turns the platform (85) during the wash cycle at a slow speed at about 5 to 15 RPM and during dry cycle at up to 200 RPM. An extraction fan F-1 will operate during the dry cycle to remove excess moisture from the wash chamber and assist with drying. During and after the entire cycle UV light (UV-1) will operate to assist with bacteria control.

The wash manifold will consist of a central nozzle to clean the interior of the container; side nozzle(s) to clean the exterior of the container as well as the lid and possible teat. A dedicated nozzle is fitted to clean straws. All nozzles are fixed to suit maximum performance. A pressure switch PP will monitor pressure in the manifold. Too low can mean no water, too high can mean blockage.

### Cycle Start

The cycle can be considered to follow the water flow as follows:

Purge Cycle

| | |
|---|---|
| Pathway/A | Used water from the previous cycle feeds to the 3-way |
| | valve |
| Pathway B | Water is fed by wash pump PW-1 (64) |
| Pathway C | Directed to wash table (83) |
| Pathway D | Fluid is expelled to assist removal of large matter such as |
| | tea bags etc. from cup |
| Pathway E | Water with large matter drops from the cleaning table |
| | into sump (70) |
| Pathway F | With the gate or sump door (73) open the large matter |
| | residue drops to the pyramidal filter and the fluids |
| | proceed through filter to drain. |

Wash Cycle

| | |
|---|---|
| Pathway H | Clean heated water from tank (50) is fed to 3-way |
| | valve Y-1 |
| Pathway B | Proceeds through wash pump PW1 (64) |
| Pathway C | Directed to wash table (83) |
| Pathway D | Fed out water channels (88) and water jets (89) |
| Pathway E | Wash water from the cleaning table into sump (70) |
| Pathway G | Detergent is fed into wash cycle |
| Pathway H | With the gate or sump door (73) closed the water in sump |
| | is cycled in the wash cycle |
| Pathway I | Wash pump PW-2 (65) |
| Pathway D | Wash water cycled to be fed out water channels (88) and |
| | waterjets (89) |

Rinse Cycle

| | |
|---|---|
| Pathway H | Clean heated rinse water from tank (50) is fed to 3-way |
| | valve Y-1 |
| Pathway B | Rinse Water is fed by wash pump PW-1 (64) |
| Pathway C | Directed to wash table (83) |
| Pathway D | Rinse fluid is expelled to provide rinse of cleaned |
| | containers |
| Pathway E | Rinse water from the cleaning table into sump (70) |
| Pathway E | Rinse water from the cleaning table (83) into sump (70) |

Spin Cycle

| | |
|---|---|
| Pathway H | With the gate or sump door (73) closed the water in sump |
| | is collected from the rinse cycle |
| Pathway I | Wash pump PW-2 (65) |
| Pathway J | Diverted by three-way valve Y-3 to tank T-2 (52) for |
| | collection and recycling to be used in purge cycle of next |
| | container clean. |

When the System has just been switched on, Tank T-1 will fill with water to the required level and heat to the required temperature. From this point on the system can stay on standby. A UV light will stay on during all time the System is in standby or operating.

Open the door, lift the central hold down bar and place cup in center of platform. Place the lid in the holder on top of the hold down bar. Ensure any teat is open and facing outwards. Any rubbish such as teabags, fruit slices, coffee/tea grounds can be disposed of into the tank opening.

Close the door. If fitted with start button, push, otherwise the unit will auto-start within a few seconds.

The central platform will start to slowly rotate. Valve Y-C will open. Valve/Y-1 is in open position with ports 1 & 2 open. Valve Y-2 is in open position with ports 1 & 2 open. Valve Y-3 is in closed position ports 1 & 3. Tank T-3 actuators are open. Pump PW-1 will draw water from tank T-1 and spray over the cup/lid. This water will go directly to the drain. This is the purge cycle. After about 5-10 seconds the actuators AC-1 will close the wash tank T-3 opening and subsequently the tank will fill with the remaining water from tank T-1. When T-1 is empty (sensor LS-1) valve Y-C will close, pump PW-1 will stop. Valve Y-2 will close (port 1 & 3). Pump PW-2 will start and draw water from tank T-3 and pump via valve Y-3 port 1 & 2, through the nozzles in the main manifold. This water will fall into wash tank T-3 and recirculate via inline filter FL-1 for a preset time (60 seconds).

A detergent will be added to tank-T 3 from pump PD-1.

After the preset wash time has been reached, actuator valve AC-1 will open, water will drain from tank and after a few seconds, pump PW-2 will stop. The dirty wash water has now been dumped.

Next phase is rinse. Valve Y-3 will close (port 1 & 3), valve Y-2 will open (1 & 2), valve Y-C will open, actuators AC will close, and pump PW-1 will spray clean water over the cup and lid. A sanitizer will be added through pump PS-1 during this cycle.

At the end of the rinse cycle, valve Y-C will close, pump PW-1 and PS-1 will stop. Fan F-1 will remove excess moisture from cabinet and drive motor DM-1 will increase in speed to remove excess water. Valve Y-4 will be open (port 1 & 2), valve Y-3 will close (port 1 & 3). Pump PW-2 will remove water from wash tank T-3 and pump into tank T-2. Valve Y-B will top up if not sufficient water to reach level sensor. Tank T-2 will be heated but only when tank T-1 has reached temperature.

After a set spin time the cycle has been completed, and the door can be opened. This is indicated by a sound or visible indicator.

The system now sets up for the next cycle. However instead of using water in tank T-1, the water in tank T-2 is used for the next wash.

Place items in the cabinet and let cycle start. Valve Y-1 is closed (port 1 & 3). Pump PW-1 draws water from tank T-2. Valve Y-2 is open (port 1 & 2), valve Y-3 is closed port (1 & 3). Actuator in tank T-3 is open for a few seconds, then closes. Detergent is added via PD-1. After the wash cycle, the actuators open and water is drained. The rinse cycle starts as previous.

### Self-Cleaning

At preset times the system will clean itself. Tank T-1 will heat to 82 °C. Valve Y-C will open, valve Y-1 is open (port 1 & 2), pump PW-01 is activated as well as sanitizer pump PS-1. Tank T-3 actuators are open. Valve Y-3 is closed (port 1 & 3). Hot water is sprayed through wash chamber (platform is rotating) and straight to drain. When tank T-1 is empty, pump PW-1 stops. Valve Y-C closes. Valve Y-1 closes (port 1 & 3), sanitizer pump PS-1 is activated. Valve Y-2 and Y-3 close (port 1 and 3). Water is pumped in reverse through filter FL-1 to back wash. When level sensor in tank T-2 is activated pump PW-1 stops and valves Y-2 and Y-3 revert to open (port 1 & 2). Actuator AC stays open.

The system is ready for the next cycle.

### PLC

All times and temperatures to be set in a Programmable Logic Controller (PLC). The platform speeds are preset but dual speeds are activated by PLC. Programs can be set by RFID in cup/bottles. This includes multiple phases.

### Misuse

In case of cup being forgotten in the apparatus, a 3D scanner will scan for a set time. If the cup is not removed after this time, a warning alert will begin, and the machine will count down before door closing. Cup will be removed once door closes via a telescopic arm housed next to chamber. The arm will reach out for items, 3D scanner will scan item and based on shape, container will be picked up and placed in storage bin. IoT alerts users, owners, and maintenance.

In case of misuse and inability to verify user, cup will be removed using same method previously stated.

Gripper or telescopic arm (87) is used to hold container securely. A retractable mechanism is used to secure the container. This includes gripping brackets. Once the container is detected and the doors are closed, the mechanism will slowly close. The holding mechanism will be sitting on a guide carriage, consisting of ball screw and spindle. Ball screw will convert the rotary motion of the servo motor into linear motion of the clamping surface. This system will compromise of 2 linear units, coupled together to close the gripping mechanism at the same time evenly on the container.

The grip mechanism travels on a track with integrated torque limit sensors, the torquemeter will send the signal to PLC to notify grip arms have secured the container, servo motor will be signaled to stop. The unit will have an overrun limit switch to prevent malfunction. Stroke length of motion unit will be determined based on container size, maximum stroke length set via PLC.

The frame is formed of stainless steel with provisions for interactive displays. Stainless steel provides the ability to be cleaned with acetone or a similar product.

A solar panel and battery can be incorporated for a more environmentally friendly product with an interactive display to be a durable touch screen with three variations:
interactive screen, wash, and fill;
wash and fill; and
wash.

A fill station is housed opposite to the wash chamber to dispense rages and can incorporate fridge, space for bladders of premix drinks. There is a user interface that allows selection of rages (can also be selected via app) which signals PLC for dispensing.

Card details are linked to app/chip/customer database to allow payment. Cup/bottle will only be filled pending payment and last registered clean. Cup/bottle to be filled based on registered capacity of NFC/RFID in cup. Door security/safety mechanism same set up as wash chamber, door remain open for duration of filling.

Maintenance is provided by the machine being modular and with ability for hoses, electricals, pipes to be disconnected easily with minimal manual labor to remove the system allowing easy repair, cleaning, replacement etc. It is also possible to remove front panels, the system is click-in, to remove unclick and slide out system on the drawer slides.

### Refilling Station

For units with a filling section, the vessel can then be placed in a similar manner into a separate filling station. Depending on available options still or sparkling water or other drink can be dispensed. The costs will be charged to or deducted from a preloaded data source. Stock levels of product will be sent to relevant retailers.

If the container is used for refilling condiments from a delicatessen, then the retailer can automatically retrieve cleaning and sanitizing data and ensure it complies with their safety guidelines. Furthermore, cost and weight plus nutritional information of the product can be embedded for later retrieval.

### Modular System

The module housing is designed to accommodate the required wash, rinse and sanitize module. This module can be circular or square.

The module may contain one or more of the following:
(a) wash, rinse, sanitize, and drying module;
(b) freshwater storage tank;
(c) wastewater storage tank;
(d) liquid drink dispenser;
(e) ice dispenser;
(f) solar panels and associated batteries;
(g) LCD or similar display screen for advertising or information messages; and/or
(h) water filters and/or water electrolysis system;

It can be seen the invention provides a controlled personal container washing and sanitizing apparatus for use by individuals in public places and food outlets to clean and sanitize single reusable personal containers such as, but not limited to, cups, beakers, mugs, bottles, food containers, punnets, as well as their respective lids, and similar items used to contain food or drink for personal or family use with a maximum capacity of 5 liters. Said container is automatically washed and rinsed and spin dried to a food standards acceptable level with controlled data recognition and communication protocols to guarantee safe and personal security of said container's cleaning and sanitizing efficacy.

The apparatus will also be capable of dispensing water or any other drinkable liquid in the cleaned container thus ensuring the food safety and product quality are maintained to preset protocols. In particular it could replace public water drinking fountains that currently have few if any cleaning and safeguarding protocols.

Minimizing the use of single use products is critical in managing the world's environment and subsequent global warming.

Recycling single use items is akin to managing the effects caused by a situation rather than preventing the situation occurring in the first place. As a minimum a single use item needs to be collected, transported to a sorting station, sorted, cleaned and made ready for reuse in most cases at a different location. All these steps have an environmental impact. In most cases a lot of single use items cannot be recycled or have a limited recycling circuit.

The circular economy is based on a model that involves sharing, reusing, repairing or recycling existing materials and products as long as possible.

The most cost effective and least impact on the environment is a model whereby a product is simply reused with minimal input of resources.

The most renewable resources would be electricity (solar/hydro) and water. Using these resources in an efficient manner would contribute greatly to reducing the use of fossil fuels and consequently the impact on the environment.

The system described below is designed to eliminate single use items and reuse cups, bottles and containers using renewable resources.

Cleaning devices have been in use for many years. Typically cleaning devices are designed to accommodate and clean multiple items at once or in certain cases to rinse and/or steam single items without a validated cleaning and sanitizing process.

The system is designed to allow for on the spot cleaning and sanitizing of personal or single containers as well as dispensing water or other rages as required into the said container.

So called keep cups have been in use for many years and have contributed to the reduction of single use items. However, there is little or no control over the cleanliness of these containers.

The condition of the container could have a significant impact on the quality of the product being served by a third party or even worse the hygiene state and possible consequences for public health.

There are systems whereby soiled/used keep cups are exchanged for clean ones. These systems are often linked to specific suppliers and still require collection, sorting, cleaning, and redistribution.

For many retailers refilling private or personal food containers poses the problem of guaranteed cleanliness. Our system will log when (time stamped) the container was cleaned and that the set cleaning and sanitizing cycle protocols were met, and this data can be retrieved and verified at point of sale.

The system allows the container user to clean and sanitize their item on the spot for immediate reuse. No collection or accumulation. Simply place the soiled container in the unit to be washed and sanitized ready for use.

After the cleaning and sanitizing process, the container, if a drinking vessel, can be refilled with a selected rage.

The cleaning process-controlled data recognition and communication protocols to guarantee safe and personal security of said container's cleaning and sanitizing efficacy will be achieved via NFC/RFID or similar device embedded in the container.

Current concepts and designs rely on, or off-site cleaning and sanitizing based on an exchange of containers. Other concepts and designs rely on accumulation and mass cleaning and sanitizing of containers. Other concepts and designs rely on assumed data.

Our invention substantially departs from current concepts and designs in that it is a personal food container cleaning and sanitizing device to be used in public or retail places with verifiable cleaning and sanitizing protocols. Our invention is to reduce the need for single use containers.

It is envisaged that bottling companies can supply current “post-mix” drinks in our invention eliminating the need for supplying bottles/containers, bulk transport costs, storage refrigerators with associated environmental costs.

Consumers visiting food retail outlets such as supermarket delis can bring their own container and the supplier can verify that the container has been cleaned and sanitized according to set protocols such as time delay, cleaning efficacy, rotation times of container, etc.

It is envisaged that the cleaning and sanitizing apparatus will be installed at appropriate space in retailer's premises or open public spaces.

It can be seen that the invention has one or more novel features or combination of features included from the list of:
(a) PURGE CYCLE: No need to prerinse or scrape wares. The open-ended design of the wash tank allows residual waste to be removed from the wash cabinet before cycle commencement.
(b) CURVED WASH TANK: The wash tank design can be up to 90° to minimize vortex created by pump suction. It also allows for easy removal of debris during purge cycle and minimizes water consumption.
(c) WASH TANK LID: An actuator-controlled flap at one end of the wash tank allows it to be open and for waste to be directly removed from the wash tank.
(d) EXTERNAL WASH TANK FILTER: As opposed to current dishwashing machines, our filter is placed outside the wash tank and wash chamber. This prevents soil from being recirculated or contaminating the wash tank water. The filter can be removed during a cycle.
(e) REMOVABLE WASH PLATFORM: Items are placed on a removable platform inside the wash chamber. The platform can either rotate or be stationary depending on the chosen cycle. The platform can be set up to suit different wash up items.
(f) REMOVABLE SPRAY MANIFOLD: In combination with the removable wash platform the spray manifold assembly can be removed to suit the different wash platform.
(g) SPIN DRYING: During the drying phase the wash platform will spin at higher revolutions than during wash cycle thus removing excess water in combination with blower. No need for high power or heated air jets.
(h) WASHING STRAWS: A special washing platform to clean and sanitize metal or plastic straws both internally and externally.
(i) TEAT WASHING: A special platform and jet manifold to clean and sanitize drinking bottle teats.
(j) INCORPORATED DRINK BOTTLE FILL: A liquid (hot or cold) can be dispenser after the bottle has been cleaned and sanitized. Incorporated within the structure of the machine is a dispensing system that.
(k) INDIVIDUAL DATA LOGGING: Individual cup/bottle ownership, cleaning history and drink/food request data is recorded via a chip/RFID within the cup/bottle and phone app.

Other embodiments would be understood and are included within the scope of this document.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### TERMINOLOGY

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward,” “rearward,” “radially,” “peripherally,” “upwardly,” “downwardly,” and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e., to specify the presence of the stated features but not to preclude the presence or addition of further features in various embodiments of the invention.

Any one of the terms: including or which includes or that includes as used herein is also an open term that also means including at least the elements/features that follow the term but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above that the arrangements described are applicable to the food storage industries and particularly to the takeaway food service industries.

What is claimed is:

1-44. (canceled)

45. A container reuse system for cleaning containers so as to allow reuse of a container in a cleaned state, the system including:
a. a container-receiving station formed and configured to be able to receive a container to be cleaned;
b. a cleaning device cooperating with the container-receiving station and configured to clean the container in the container-receiving station; and
c. a controller configured to control the cleaning device relative to the container to enable the container to be readily cleaned.

46. The container reuse system of claim 45 wherein the controller coordinates with the container to provide a defined cleaning process and transfers data regarding the cleaning process to the container which can be read at a reuse station.

47. The container reuse system of claim 46 wherein the controller includes a clock for identifying time of cleaning and extent of clean and transfers data regarding the cleaning process to the container which can be read at a reuse station.

48. The container reuse system of claim 46 wherein the cleaning device includes a liquid circulation system including:
d. a liquid retention chamber able to receive the container-receiving station;
e. a liquid feed into the liquid retention chamber to wash or rinse the container and parts in the container-receiving station;
f. a purge system for selectively exiting liquid and solids from the liquid retention chamber; and
g. wherein solids in a container to be cleaned or rinsed can first be purged of solids and wherein the purge system includes a refuse system.

49. The container reuse system of claim 48 wherein the liquid circulation system includes a connection to a first tank and a second tank wherein clean liquid can be fed to the first tank and purged water from an openable sump can be fed to the second tank wherein the purged water from second tank can be reused in a step of the cleaning process.

50. The container reuse system of claim 48 further comprising:
h. an openable sump for allowing flushing of refuse in a first action;
i. a pump for drawing liquid and solids into the openable sump;
j. a filter for allowing substantial separation of liquids and solids;
k. a rubbish trap for retaining separated solids while allowing passage of liquids back to the liquid circulation system; and
l. wherein the openable sump includes a curved or angled direct pipe and the pump is offset to the pipe to allow clear unhindered flow to the filter and rubbish trap when the openable sump is open.

51. The container reuse system of claim 50 wherein the filter is a pyramidal filter whereby solids are able to slide down the greater quantity of surface area of filter while allowing ready transmission of the liquids and
wherein the rubbish trap with the pyramidal filter can allow solids to accumulate but still allow water flow for wash cycles and thereby can be emptied at maintenance periods rather than at each wash cycle.

52. The container reuse system of claim 46 including:
a. a container formed and configured to be able to be readily cleaned and reused;
b. a cleaning device configured to be able to readily clean the container;
c. a controller configured to control the cleaning device to enable the container to be readily cleaned and reused; and
d, wherein the container is formed of food quality materials including one or more of: food-quality plastic, food-quality glass, and food-quality stainless steel.

53. The container reuse system of claim 52 wherein the cleaning device includes:
h. a compartment associated with at least one cleaning mechanism for receiving the container to be cleaned;
i. a connection to a supply of cleaning elements including one or more of: water, heat, and chemicals;
j. at least one sensor device for sensing the container; and
k. undertaking a controlled cleaning procedure on the container.

54. The container reuse system of claim 53 wherein the cleaning procedure can be undertaken in a time period of less than three times the time period for using the container such as in a time period of less than three times the time period for making a barista-quality coffee in the reused container.

55. The container reuse system of claim 53 wherein the controller for controlling the cleaning procedure receives a selected cleaning process and controls the selected cleaning process on the container.

56. The container reuse system of claim 53 wherein the cleaning device comprises:
at least one display device for allowing display of an output to at least one of each of a plurality of users;
wherein the compartment for receiving the container includes a controlled access port to the compartment for receiving the container to at least one cleaning mechanism;
at least one device for transmitting cleaning status of each user-particular container provided to the controlled access port;
at least one receiver for receiving by at least one device for transmitting cleaning status for allowing identification of status of the respective confirmed container for at least one of each user;
at least one security device for allowing a container of each of the plurality of users to provide a user-particular input to the controlled access port; and
wherein the at least one device for transmitting cleaning status of each user-particular container provided to the controlled access port is an RFID/NFC writer for writing to an RFID device on the container for carrying a status with the container wherein the status associated with the container includes one or more of: container identity, cleaning procedure undertaken, time of cleaning procedure, location of cleaning, number of lifetime cleans, and assessment of container quality.

57. The container reuse system of claim 53 wherein the controller receives the controlled cleaning procedure to be undertaken:
i. on the container from a remote source and controls and instructs the cleaning device according to the controlled cleaning procedure; or
ii. automatically from a store according to their requirements; or
iii. from automatic receipt of instruction by a sensor device interacting with a device on or in the container providing the controlled cleaning procedure to be undertaken on the container.

58. The container reuse system of claim 57 wherein the sensor device interacts with an RFID device on the container for reading a status and required cleaning instructions.

59. The container reuse system of claim 58 wherein the required cleaning instructions can include a predetermined combination of one or more of: with or without chemicals, with hot water at a high range, with hot water at a medium range, with or without chlorine, with a predetermined time period, with drip dry, and with high heat drying.

60. The container reuse system of claim 45 wherein the container-receiving station is mountable within the cleaning device by at least one pivot point for allowing spinning of the container-receiving station,
wherein the container-receiving station rotates at a low rate allowing liquid to be received on a container and parts in the container-receiving station, and
wherein the container-receiving station rotates at a high rate allowing liquid on the container and parts in the container-receiving station to be removed by centrifugal forces.

61. The container reuse system of claim 45 wherein the system includes:
i. a first refuse removal or purge step;
ii. a cleaning step;
iii. a rinsing step; and
iv. a drying step.

62. The container reuse system of claim 45 further comprising an API to manage and control said features and operation.

63. The container reuse system of claim 45 further comprising a cleaning device including:
d. a wash chamber with rotating shelf, automatic door, and UV lighting;
e. a receiver for receiving containers with imbedded devices to start and record wash, rinse, sanitize, and dry cycles as well as such information that is required to assure set cleaning and sanitizing protocols have been met;
f. a self-cleaning cycle and filter for system to individually wash, rinse, sanitize, and dry single personal containers, with lids, of no more than 5-liter capacity; and
g. wherein the cleaning device includes one or more cleaning mechanisms selected from the group consisting of: physical scraping, jet flow, chemical treating, oxidizing, and heat treating.

64. A method of providing a container reuse system, the method including the steps of:
a. providing a cleaning device enabling cleaning of a particular container separately;
b. receiving a required cleaning instruction regarding a particular received container;
c. undertaking the required cleaning instruction regarding the particular received container;
d. providing an output showing the particular received container has undertaken the required cleaning as instructed;
e. undertaking a reuse of the received container that has been shown to have undertaken the required cleaning as instructed; and
f. wherein the cleaning is undertaken at a cleaning device comprising a controlled standalone system to individually wash, rinse, sanitize, and dry single food containers, with lids, of no more than 5-liter capacity.

65. The method of claim 64 including the steps of:
g. providing a container having a status carrying a RFID device;
h. receiving a required cleaning instruction related to the identified container;
i. cleaning according to the required cleaning instruction related to the identified container;
j. updating status to a clean container status in the status of the RFID device in the container; and
k. presenting the clean status container as shown by the status of the RFID device in the container for reuse of the container.
